(19) United States
(12) Patent Application Publication
(10) Pub. No.: US 2013/0182586 A1
(43) Pub. Date: Jul. 18, 2013

(54) OBTAINING COMMUNICATION SESSION INITIATION INFORMATION IN A WIRELESS COMMUNICATIONS SYSTEM

(71) Applicants: Karthika Paladugu, San Diego, CA (US); Yih-Hao Lin, San Diego, CA (US)

(72) Inventors: Karthika Paladugu, San Diego, CA (US); Yih-Hao Lin, San Diego, CA (US)

(73) Assignee: QUALCOMM INCORPORATED, San Diego, CA (US)

(21) Appl. No.: 13/352,529

(22) Filed: Jan. 18, 2012

(51) Int. Cl. H04W 52/02; H04W 24/00

(52) U.S. Cl. 370/252; 370/311

(57) ABSTRACT

In an embodiment, a user equipment (UE) receives request to set-up a communication session of a given type while the UE is in a dormant state (e.g., URA_PCH or CELL_PCH). The UE configures a state transition request message (e.g., a cell update message) (i) to request that an access network transition the UE from the dormant state to a target state (e.g., CELL_FACH or CELL_DCH) and to obtain a network-assigned serving cell-specific identifier (e.g., C-RNTI) for exchanging data between the UE and the serving cell in association with the communication session of the given type and (ii) to indicate the given type of the communication session. The UE transmits the state transition request message to the access network, and the access network determines the given type of the communication session based on the state transition request message.

### BACKGROUND OF THE INVENTION

1. Field of the Invention

Embodiments of the invention relate to obtaining communication session information in a wireless communications system.

2. Description of the Related Art

Wireless communication systems have developed through various generations, including a first-generation analog wireless phone service (1G), a second-generation (2G) digital wireless phone service (including interim 2.5G and 2.75G networks) and a third-generation (3G) high speed data/Internet-capable wireless service. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

The method for providing CDMA mobile communications was standardized in the United States by the Telecommunications Industry Association/Electronic Industries Association in TIA/EIA/IS-95-A entitled “Mobile Station-Base Station Compatibility Standard for Dual-Mode Wideband Spread Spectrum Cellular System,” referred to herein as IS-95. Combined AMPS & CDMA systems are described in TIA/EIA Standard IS-98. Other communications systems are described in the IMT-2000/UM, or International Mobile Telecommunications System 2000/Universal Mobile Telecommunications System, standards covering what are referred to as wideband CDMA (W-CDMA), CDMA2000 (such as CDMA2000 1xEV-DO standards, for example) or TD-SCDMA.

In W-CDMA wireless communication systems, user equipments (UEs) receive signals from fixed position Node Bs (also referred to as cell sites or cells) that support communication links or service within particular geographic regions adjacent to or surrounding the base stations. Node Bs provide entry points to an access network (AN)/radio access network (RAN), which is generally a packet data network using standard Internet Engineering Task Force (IETF) based protocols that support methods for differentiating traffic based on Quality of Service (QoS) requirements. Therefore, the Node Bs generally interacts with UEs through an over the air interface and with the RAN through Internet Protocol (IP) network data packets.

In wireless telecommunication systems, Push-to-talk (PTT) capabilities are becoming popular with service sectors and consumers. PTT can support a “dispatch” voice service that operates over standard commercial wireless infrastructures, such as W-CDMA, CDMA, FDMA, TDMA, GSM, etc. In a dispatch model, communication between endpoints (e.g., UEs) occurs within virtual groups, wherein the voice of one “talker” is transmitted to one or more “listeners.” A single instance of this type of communication is commonly referred to as a dispatch call, or simply a PTT call. A PTT call is an instantiation of a group, which defines the characteristics of a call. A group in essence is defined by a member list and associated information, such as group name or group identification.

### SUMMARY

In an embodiment, a user equipment (UE) receives request to set-up a communication session of a given type while the UE is in a dormant state (e.g., URA_PCH or CELL_PCH). The UE configures a state transition request message (e.g., a cell update message) (i) to request that an access network transition the UE from the dormant state to a target state (e.g., CELL_FACH or CELL_DCH) and to obtain a network-assigned serving cell-specific identifier (e.g., C-RNTI) for exchanging data between the UE and the serving cell in association with the communication session of the given type and (ii) to indicate the given type of the communication session. The UE transmits the state transition request message to the access network, and the access network determines the given type of the communication session based on the state transition request message.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 is a diagram of a wireless network architecture that supports user equipments and radio access networks in accordance with at least one embodiment of the invention.

FIG. 2A illustrates the core network of FIG. 1 according to an embodiment of the present invention.

FIG. 2B illustrates an example of the wireless communications system of FIG. 1 in more detail.

FIG. 3 is an illustration of a user equipment (UE) in accordance with at least one embodiment of the invention.

FIG. 4A illustrates operation of the UE in accordance with an embodiment of the invention.

FIG. 4B illustrates operation of an access network in accordance with an embodiment of the invention.

FIG. 5A illustrates a more detailed implementation of FIGS. 4A and 4B in accordance with an embodiment of the invention.

FIG. 5B illustrates an example implementation of FIG. 5A where the given type of communication session being set-up corresponds to a direct call session to be arbitrated by an application server in accordance with an embodiment of the invention.

FIG. 5C illustrates another example implementation of FIG. 5A where the given type of communication session being set-up corresponds to an alert message session to be arbitrated by the application server in accordance with another embodiment of the invention.

FIGS. 6A through 6E each illustrate a different example implementation of cell update message evaluation logic that can be provisioned at, or executed by, the access network to determine a session-type associated with a received cell update message for a dormant UE in accordance with an embodiment of the invention.

FIG. 7A is directed to an example implementation of FIG. 5A in accordance with the session-type evaluation logic of any of FIGS. 6A through 6E in a scenario whereby the access network maintains an always-on Iu-PS signaling connection for an originating UE in accordance with an embodiment of the invention.

FIG. 7B illustrates an example implementation of FIG. 7A where the given type of communication session being set-up corresponds to a direct call session to be arbitrated by the application server 170 in accordance with an embodiment of the invention.

FIG. 7C illustrates another example implementation of FIG. 7A where the given type of communication session being set-up corresponds to an alert message session to be arbitrated by the application server in accordance with another embodiment of the invention.

FIGS. 8A-8B are directed to an example implementation of FIG. 5A in accordance with the session-type evaluation logic of any of FIGS. 6B through 6E in a scenario whereby the access network does not maintain an always-on Iu-PS signaling connection for the originating UE in accordance with embodiments of the invention.

FIGS. 9A-9B illustrate an example implementation of FIGS. 8A-8B where the given type of communication session being set-up corresponds to a direct call session to be arbitrated by the application server in accordance with an embodiment of the invention.

FIGS. 10A-10B illustrate another example implementation of FIGS. 8A-8B where the given type of communication session being set-up corresponds to an alert message session to be arbitrated by the application server in accordance with another embodiment of the invention.

FIG. 11 illustrates a communication device that includes logic configured to perform functionality in accordance with an embodiment of the invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A High Data Rate (HDR) subscriber station, referred to herein as user equipment (UE), may be mobile or stationary, and may communicate with one or more access points (APs), which may be referred to as Node Bs. A UE transmits and receives data packets through one or more of the Node Bs to a Radio Network Controller (RNC). The Node Bs and RNC are parts of a network called a radio access network (RAN). A radio access network can transport voice and data packets between multiple UEs.

The radio access network may be further connected to additional networks outside the radio access network, such core network including specific carrier related servers and devices and connectivity to other networks such as a corporate intranet, the Internet, public switched telephone network (PSTN), a Serving General Packet Radio Services (GPRS) Support Node (SGSN), a Gateway GPRS Support Node (GGSN), and may transport voice and data packets between each UE and such networks. A UE that has established an active traffic channel connection with one or more Node Bs may be referred to as an active UE, and can be referred to as being in a traffic state. A UE that is in the process of establishing an active traffic channel (TCH) connection with one or more Node Bs can be referred to as being in a connection setup state. A UE may be any data device that communicates through a wireless channel or through a wired channel. A UE may further be any of a number of types of devices including but not limited to PC card, compact flash device, external or internal modem, or wireless or wireline phone. The communication link through which the UE sends signals to the Node B(s) is called an uplink channel (e.g., a reverse traffic channel, a control channel, an access channel, etc.). The communication link through which Node B(s) send signals to a UE is called a downlink channel (e.g., a paging channel, a control channel, a broadcast channel, a forward traffic channel, etc.). As used herein the term traffic channel (TCH) can refer to either an uplink/reverse or downlink/forward traffic channel.

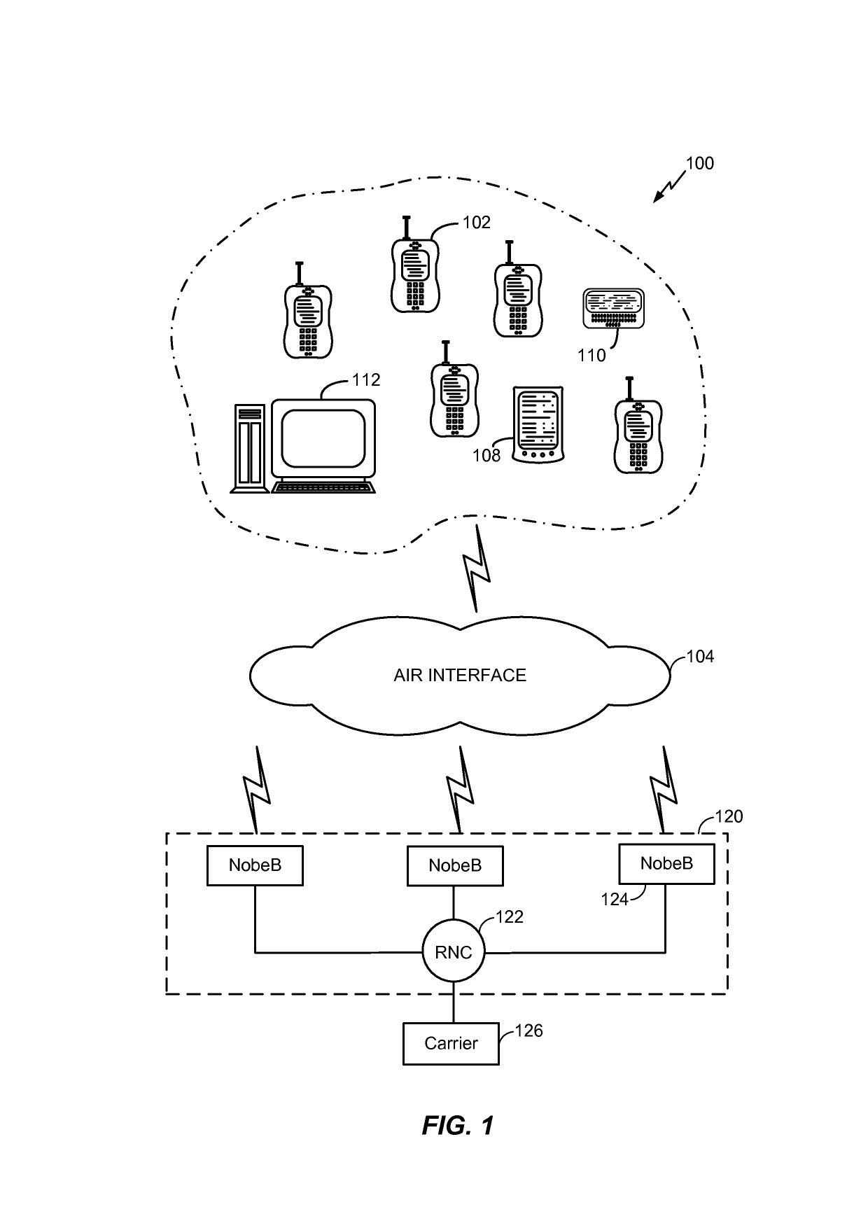

FIG. 1 illustrates a block diagram of one exemplary embodiment of a wireless communications system 100 in accordance with at least one embodiment of the invention. System 100 can contain UEs, such as cellular telephone 102, in communication across an air interface 104 with an access network or radio access network (RAN) 120 that can connect the access terminal 102 to network equipment providing data connectivity between a packet switched data network (e.g., an intranet, the Internet, and/or core network 126) and the UEs 102, 108, 110, 112. As shown here, the UE can be a cellular telephone 102, a personal digital assistant 108, a pager 110, which is shown here as a two-way text pager, or even a separate computer platform 112 that has a wireless communication portal. Embodiments of the invention can thus be realized on any form of access terminal including a wireless communication portal or having wireless communication capabilities, including without limitation, wireless modems, PCMCIA cards, personal computers, telephones, or any combination or sub-combination thereof. Further, as used herein, the term “UE” in other communication protocols (i.e., other than W-CDMA) may be referred to interchangeably as an “access terminal”, “AT”, “wireless device”, “client device”, “mobile terminal”, “mobile station” and variations thereof.

Referring back to FIG. 1, the components of the wireless communications system 100 and interrelation of the elements of the exemplary embodiments of the invention are not limited to the configuration illustrated. System 100 is merely exemplary and can include any system that allows remote UEs, such as wireless client computing devices 102, 108, 110, 112 to communicate over-the-air between and among each other and/or between and among components connected via the air interface 104 and RAN 120, including, without limitation, core network 126, the Internet, PSTN, SGSN, GGSN and/or other remote servers.

The RAN 120 controls messages (typically sent as data packets) sent to a RNC 122. The RNC 122 is responsible for signaling, establishing, and tearing down bearer channels (i.e., data channels) between a Serving General Packet Radio Services (GPRS) Support Node (SGSN) and the UEs 102/108/110/112. If link layer encryption is enabled, the RNC 122 also encrypts the content before forwarding it over the air interface 104. The function of the RNC 122 is well-known in the art and will not be discussed further for the sake of brevity. The core network 126 may communicate with the RNC 122 by a network, the Internet and/or a public switched telephone network (PSTN). Alternatively, the RNC 122 may connect directly to the Internet or external network. Typically, the network or Internet connection between the core network 126 and the RNC 122 transfers data, and the PSTN transfers voice information. The RNC 122 can be connected to multiple Node Bs 124. In a similar manner to the core network 126, the RNC 122 is typically connected to the Node Bs 124 by a network, the Internet and/or PSTN for data transfer and/or voice information. The Node Bs 124 can broadcast data messages wirelessly to the UEs, such as cellular telephone 102. The Node Bs 124, RNC 122 and other components may form the RAN 120, as is known in the art. However, alternate configurations may also be used and the invention is not limited to the configuration illustrated. For example, in another embodiment the functionality of the RNC 122 and one or more of the Node Bs 124 may be collapsed into a single “hybrid” module having the functionality of both the RNC 122 and the Node B(s) 124.

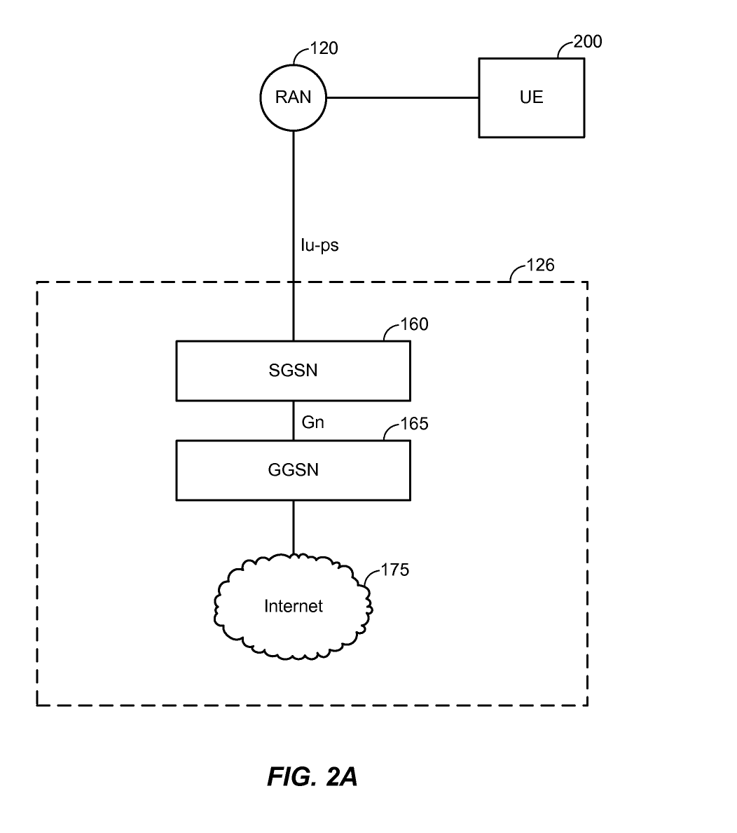

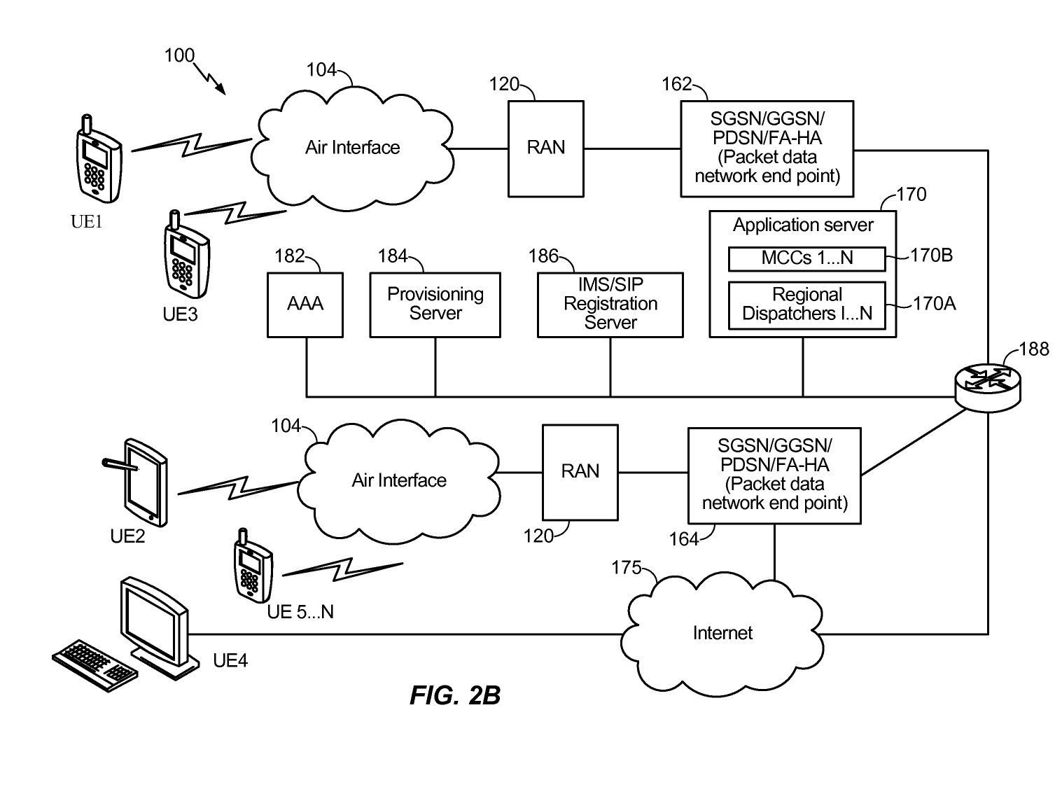

FIG. 2A illustrates the core network 126 according to an embodiment of the present invention. In particular, FIG. 2A illustrates components of a General Packet Radio Services (GPRS) core network implemented within a W-CDMA system. In the embodiment of FIG. 2A, the core network 126 includes a Serving GPRS Support Node (SGSN) 160, a Gateway GPRS Support Node (GGSN) 165 and an Internet 175. However, it is appreciated that portions of the Internet 175 and/or other components may be located outside the core network in alternative embodiments.

Generally, GPRS is a protocol used by Global System for Mobile communications (GSM) phones for transmitting Internet Protocol (IP) packets. The GPRS Core Network (e.g., the GGSN 165 and one or more SGSNs 160) is the centralized part of the GPRS system and also provides support for W-CDMA based 3G networks. The GPRS core network is an integrated part of the GSM core network, provides mobility management, session management and transport for IP packet services in GSM and W-CDMA networks.

The GPRS Tunneling Protocol (GTP) is the defining IP protocol of the GPRS core network. The GTP is the protocol which allows end users (e.g., access terminals) of a GSM or W-CDMA network to move from place to place while continuing to connect to the internet as if from one location at the GGSN 165. This is achieved transferring the subscriber's data from the subscriber's current SSGN 160 to the GGSN 165, which is handling the subscriber's session.

Three forms of GTP are used by the GPRS core network; namely, (i) GTP-U, (ii) GTP-C and (iii) GTP′ (GTP Prime). GTP-U is used for transfer of user data in separated tunnels for each packet data protocol (PDP) context. GTP-C is used for control signaling (e.g., setup and deletion of PDP contexts, verification of GSN reach-ability, updates or modifications such as when a subscriber moves from one SGSN to another, etc.). GTP′ is used for transfer of charging data from GSNs to a charging function.

Referring to FIG. 2A, the GGSN 165 acts as an interface between the GPRS backbone network (not shown) and the external packet data network 175. The GGSN 165 extracts the packet data with associated packet data protocol (PDP) format (e.g., IP or PPP) from the GPRS packets coming from the SGSN 160, and sends the packets out on a corresponding packet data network. In the other direction, the incoming data packets are directed by the GGSN 165 to the SGSN 160 which manages and controls the Radio Access Bearer (RAB) of the destination UE served by the RAN 120. Thereby, the GGSN 165 stores the current SGSN address of the target UE and his/her profile in its location register (e.g., within a PDP context). The GGSN is responsible for IP address assignment and is the default router for the connected UE. The GGSN also performs authentication and charging functions.

The SGSN 160 is representative of one of many SGSNs within the core network 126, in an example. Each SGSN is responsible for the delivery of data packets from and to the UEs within an associated geographical service area. The tasks of the SGSN 160 includes packet routing and transfer, mobility management (e.g., attach/detach and location management), logical link management, and authentication and charging functions. The location register of the SGSN stores location information (e.g., current cell, current VLR) and user profiles (e.g., IMSI, PDP address(es) used in the packet data network) of all GPRS users registered with the SGSN 160, for example, within one or more PDP contexts for each user or UE. Thus, SGSNs are responsible for (i) de-tunneling downlink GTP packets from the GGSN 165, (ii) uplink tunnel IP packets toward the GGSN 165, (iii) carrying out mobility management as UEs move between SGSN service areas and (iv) billing mobile subscribers. As will be appreciated by one of ordinary skill in the art, aside from (i)-(iv), SGSNs configured for GSM/EDGE networks have slightly different functionality as compared to SGSNs configured for W-CDMA networks.

The RAN 120 (e.g., or UTRAN, in Universal Mobile Telecommunications System (UMTS) system architecture) communicates with the SGSN 160 via an Iu interface, with a transmission protocol such as Frame Relay or IP. The SGSN 160 communicates with the GGSN 165 via a Gn interface, which is an IP-based interface between SGSN 160 and other SGSNs (not shown) and internal GGSNs, and uses the GTP protocol defined above (e.g., GTP-U, GTP-C, GTP′, etc.). While not shown in FIG. 2A, the Gn interface is also used by the Domain Name System (DNS). The GGSN 165 is connected to a Public Data Network (PDN) (not shown), and in turn to the Internet 175, via a Gi interface with IP protocols either directly or through a Wireless Application Protocol (WAP) gateway.

The PDP context is a data structure present on both the SGSN 160 and the GGSN 165 which contains a particular UE's communication session information when the UE has an active GPRS session. When a UE wishes to initiate a GPRS communication session, the UE must first attach to the SGSN 160 and then activate a PDP context with the GGSN 165. This allocates a PDP context data structure in the SGSN 160 that the subscriber is currently visiting and the GGSN 165 serving the UE's access point.

FIG. 2B illustrates an example of the wireless communications system 100 of FIG. 1 in more detail. In particular, referring to FIG. 2B, UEs 1 . . . N are shown as connecting to the RAN 120 at locations serviced by different packet data network end-points. The illustration of FIG. 2B is specific to W-CDMA systems and terminology, although it will be appreciated how FIG. 2B could be modified to confirm with a 1x EV-DO system. Accordingly, UEs 1 and 3 connect to the RAN 120 at a portion served by a first packet data network end-point 162 (e.g., which may correspond to SGSN, GGSN, PDSN, a home agent (HA), a foreign agent (FA), etc.). The first packet data network end-point 162 in turn connects, via the routing unit 188, to the Internet 175 and/or to one or more of an authentication, authorization and accounting (AAA) server 182, a provisioning server 184, an Internet Protocol (IP) Multimedia Subsystem (IMS)/Session Initiation Protocol (SIP) Registration Server 186 and/or the application server 170. UEs 2 and 5 . . . N connect to the RAN 120 at a portion served by a second packet data network end-point 164 (e.g., which may correspond to SGSN, GGSN, PDSN, FA, HA, etc.). Similar to the first packet data network end-point 162, the second packet data network end-point 164 in turn connects, via the routing unit 188, to the Internet 175 and/or to one or more of the AAA server 182, a provisioning server 184, an IMS/SIP Registration Server 186 and/or the application server 170. UE 4 connects directly to the Internet 175, and through the Internet 175 can then connect to any of the system components described above.

Referring to FIG. 2B, UEs 1, 3 and 5 . . . N are illustrated as wireless cell-phones, UE 2 is illustrated as a wireless tablet-PC and UE 4 is illustrated as a wired desktop station. However, in other embodiments, it will be appreciated that the wireless communication system 100 can connect to any type of UE, and the examples illustrated in FIG. 2B are not intended to limit the types of UEs that may be implemented within the system. Also, while the AAA 182, the provisioning server 184, the IMS/SIP registration server 186 and the application server 170 are each illustrated as structurally separate servers, one or more of these servers may be consolidated in at least one embodiment of the invention.

Further, referring to FIG. 2B, the application server 170 is illustrated as including a plurality of media control complexes (MCCs) 1 . . . N 170B, and a plurality of regional dispatchers 1 . . . N 170A. Collectively, the regional dispatchers 170A and MCCs 170B are included within the application server 170, which in at least one embodiment can correspond to a distributed network of servers that collectively functions to arbitrate communication sessions (e.g., half-duplex group communication sessions via IP unicasting and/or IP multicasting protocols) within the wireless communication system 100. For example, because the communication sessions arbitrated by the application server 170 can theoretically take place between UEs located anywhere within the system 100, multiple regional dispatchers 170A and MCCs are distributed to reduce latency for the arbitrated communication sessions (e.g., so that a MCC in North America is not relaying media back-and-forth between session participants located in China). Thus, when reference is made to the application server 170, it will be appreciated that the associated functionality can be enforced by one or more of the regional dispatchers 170A and/or one or more of the MCCs 170B. The regional dispatchers 170A are generally responsible for any functionality related to establishing a communication session (e.g., handling signaling messages between the UEs, scheduling and/or sending announce messages, etc.), whereas the MCCs 170B are responsible for hosting the communication session for the duration of the call instance, including conducting an in-call signaling and an actual exchange of media during an arbitrated communication session.

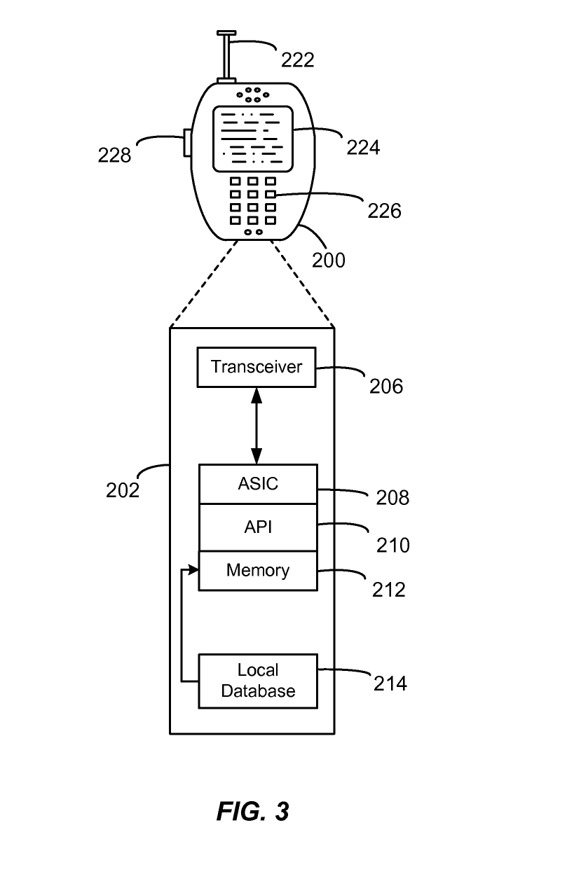

Referring to FIG. 3, a UE 200, (here a wireless device), such as a cellular telephone, has a platform 202 that can receive and execute software applications, data and/or commands transmitted from the RAN 120 that may ultimately come from the core network 126, the Internet and/or other remote servers and networks. The platform 202 can include a transceiver 206 operably coupled to an application specific integrated circuit (“ASIC” 208), or other processor, microprocessor, logic circuit, or other data processing device. The ASIC 208 or other processor executes the application programming interface (“API’) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can hold applications not actively used in memory 212. The local database 214 is typically a flash memory cell, but can be any secondary storage device as known in the art, such as magnetic media, EEPROM, optical media, tape, soft or hard disk, or the like. The internal platform 202 components can also be operably coupled to external devices such as antenna 222, display 224, push-to-talk button 228 and keypad 226 among other components, as is known in the art.

Accordingly, an embodiment of the invention can include a UE including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the UE 200 in FIG. 3 are to be considered merely illustrative and the invention is not limited to the illustrated features or arrangement.

The wireless communication between the UE 102 or 200 and the RAN 120 can be based on different technologies, such as code division multiple access (CDMA), W-CDMA, time division multiple access (TDMA), frequency division multiple access (FDMA), Orthogonal Frequency Division Multiplexing (OFDM), the Global System for Mobile Communications (GSM), or other protocols that may be used in a wireless communications network or a data communications network. For example, in W-CDMA, the data communication is typically between the client device 102, Node B(s) 124, and the RNC 122. The RNC 122 can be connected to multiple data networks such as the core network 126, PSTN, the Internet, a virtual private network, a SGSN, a GGSN and the like, thus allowing the UE 102 or 200 access to a broader communication network. As discussed in the foregoing and known in the art, voice transmission and/or data can be transmitted to the UEs from the RAN using a variety of networks and configurations. Accordingly, the illustrations provided herein are not intended to limit the embodiments of the invention and are merely to aid in the description of aspects of embodiments of the invention.

Below, embodiments of the invention are generally described in accordance with W-CDMA protocols and associated terminology (e.g., such as UE instead of mobile station (MS), mobile unit (MU), access terminal (AT), etc., RNC, contrasted with BSC in EV-DO, or Node B, contrasted with BS or MPT/BS in EV-DO, etc.). However, it will be readily appreciated by one of ordinary skill in the art how the embodiments of the invention can be applied in conjunction with wireless communication protocols other than W-CDMA.

In a conventional server-arbitrated communication session (e.g., via half-duplex protocols, full-duplex protocols, VoIP, a group session over IP unicast, a group session over IP multicast, a push-to-talk (PTT) session, a push-to-transfer (PTX) session, etc.), a session or call originator sends a request to initiate a communication session to the application server 170, which then forwards a call announcement message to the RAN 120 for transmission to one or more targets of the call.

User Equipments (UEs), in a Universal Mobile Telecommunications Service (UMTS) Terrestrial Radio Access Network (UTRAN) (e.g., the RAN 120) may be in either an idle mode or a radio resource control (RRC) connected mode.

Based on UE mobility and activity while in a RRC connected mode, the RAN 120 may direct UEs to transition between a number of RRC sub-states; namely, CELL_PCH, URA_PCH, CELL_FACH, and CELL_DCH states, which may be characterized as follows:
In the CELL_DCH state, a dedicated physical channel is allocated to the UE in uplink and downlink, the UE is known on a cell level according to its current active set, and the UE has been assigned dedicated transport channels, downlink and uplink (TDD) shared transport channels, and a combination of these transport channels can be used by the UE. In CELL_DCH state, the UE is assigned a Cell Radio Network Temporary Identifier (C-RNTI) by the RAN 120, whereby the C-RNTI uniquely identifies the UE within a current serving cell or sector and is used by the UE to transmit to the RAN 120 reverse-link data and/or receive downlink data from the RAN 120.
In the CELL_FACH state, no dedicated physical channel is allocated to the UE, the UE continuously monitors a forward access channel (FACH), the UE is assigned a default common or shared transport channel in the uplink (e.g., a random access channel (RACH), which is a contention-based channel with a power ramp-up procedure to acquire the channel and to adjust transmit power) that the UE can transmit upon according to the access procedure for that transport channel, the position of the UE is known by RAN 120 on a cell level according to the cell where the UE last made a previous cell update, and, in TDD mode, one or several USCH or DSCH transport channels may have been established. Similar to CELL_DCH state, in CELL_FACH state, the UE is assigned a C-RNTI by the RAN 120 that uniquely identifies the UE within a current serving cell or sector and is used by the UE to transmit to the RAN 120 reverse-link data and/or receive downlink data from the RAN 120.
In the CELL_PCH state, no dedicated physical channel is allocated to the UE, the UE selects a PCH with the algorithm, and uses DRX for monitoring the selected PCH via an associated PICH, no uplink activity is possible and the position of the UE is known by the RAN 120 on cell level according to the cell where the UE last made a cell update in CELL_FACH state. In CELL_PCH state, the UE is not assigned a C-RNTI, although the UE can still identify itself via a UTRAN Radio Network Temporary Identifier (U-RNTI) that uniquely identifies the UE across a wider serving area (e.g., a subnet).
In the URA_PCH state, no dedicated channel is allocated to the UE, the UE selects a PCH with the algorithm, and uses DRX for monitoring the selected PCH via an associated PICH, no uplink activity is possible, and the location of the UE is known to the RAN 120 at a Registration area level according to the UTRAN registration area (URA) assigned to the UE during the last URA update in CELL_FACH state. In URA_PCH state, the UE is not assigned a C-RNTI, although the UE can still identify itself via a U-RNTI that uniquely identifies the UE across a wider serving area (e.g., a subnet).

Accordingly, URA_PCH State (or CELL_PCH State) corresponds to a dormant state where the UE periodically wakes up to check a paging indicator channel (PICH) and, if needed, the associated downlink paging channel (PCH), and it may enter CELL_FACH state to send a Cell Update message for the following event: cell reselection, periodical cell update, uplink data transmission, paging response, re-entered service area. In CELL_FACH State, the UE may send messages on the random access channel (RACH), and may monitor a forward access channel (FACH). The FACH carries downlink communication from the RAN 120, and is mapped to a secondary common control physical channel (S-CCPCH). From CELL_FACH State, the UE may enter CELL_DCH state after a traffic channel (TCH) has been obtained based on messaging in CELL_FACH state. A table showing conventional dedicated traffic channel (DTCH) to transport channel mappings in radio resource control (RRC) connected mode, is in Table 1 as follows:

TABLE 1
DTCH to Transport Channel mappings in RRC connected mode

| | RACH | FACH | DCH | E-DCH | HS-DSCH |
|---|---|---|---|---|---|
| CELL_DCH | No | No | Yes | Yes | Yes |
| CELL_FACH | Yes | Yes | No | Yes (rel. 8) | Yes (rel. 7) |
| CELL_PCH | No | No | No | No | Yes (rel. 7) |
| URA_PCH | No | No | No | No | No |

wherein the notations (rel. 8) and (rel. 7) indicate the associated 3GPP release where the indicated channel was introduced for monitoring or access.

Communication sessions arbitrated by the application server 170, in at least one embodiment, may be associated with delay-sensitive or high-priority applications and/or services. For example, the application server 170 may correspond to a PTT server in at least one embodiment, and it will be appreciated that an important criterion in PTT sessions is fast session set-up as well as maintaining a given level of Quality of Service (QoS) throughout the session.

As discussed above, in RRC connected mode, a given UE can operate in either CELL_DCH or CELL_FACH to exchange data with the RAN 120, through which the given UE can reach the application server 170. As noted above, in CELL_DCH state, uplink/downlink Radio bearers will consume dedicated physical channel resources (e.g., UL DCH, DL DCH, E-DCH, F-DPCH, HS-DPCCH etc). Some of these resources are even consumed for high speed shared channel (i.e., HSDPA) operations. In CELL_FACH state, uplink/downlink Radio bearers will be mapped to common transport channels (RACH/FACH). Thereby, in CELL_FACH state there is no consumption of dedicated physical channel resources.

Conventionally, the RAN 120 transitions the given UE between CELL_FACH and CELL_DCH based substantially on traffic volume, which is either measured at the RAN 120 (e.g., at the serving RNC 122 at the RAN 120) or reported from the given UE itself in one or more measurement reports. Specifically, the RAN 120 can conventionally be configured to transition a particular UE to CELL_DCH state from CELL_FACH state when the UE's associated traffic volume as measured and/or reported in the uplink or as measured and/or reported in the downlink is higher than the one or more of the Event 4a thresholds used by the RAN 120 for making CELL_DCH state transition decisions.

Conventionally, when an originating UE attempts to send a call request message to the application server 170 to initiate a communication session (or an alert message to be forwarded to one or more target UEs), the originating UE performs a cell update procedure, after which the originating UE transitions to either CELL_FACH state or CELL_DCH state. If the originating UE transitions to CELL_FACH state, the originating UE can transmit the call request message on the RACH to the RAN 120. Otherwise, if the originating UE transitions to CELL_DCH state, the originating UE can transmit the call request message on the reverse-link DCH or E-DCH to the RAN 120. Call request messages are generally relatively small in size, and are not typically expected to exceed the Event 4a threshold(s) used by the RAN 120 in determining whether to transition the originating UE to CELL_DCH state.

In CELL_FACH state, the originating UE can begin transmission of the call request message more quickly (e.g., because no radio link (RL) need be established between a serving Node B and serving RNC at the RAN 120, no L1 synchronization procedure need be performed between the originating UE and the serving Node B, etc.) and no DCH-resources are consumed by the originating UE. However, the RACH is generally associated with lower data rates as compared to the DCH or E-DCH. Thus, while potentially permitting the transmission of the call request message to start earlier at an earlier point in time, the transmission of the call request message on the RACH may take a longer time to complete as compared to a similar transmission on the DCH or E-DCH in some instances. Accordingly, it is generally more efficient for the originating UE to send higher traffic volumes on the DCH or E-DCH as compared to the RACH, while smaller messages can be sent with relative efficiency on the RACH without incurring overhead from DCH set-up.

As noted above, the originating UE's state (e.g., CELL_DCH or CELL_FACH) is determined based on the amount of uplink data to be sent by the originating UE. For example, the standard defines an Event 4a threshold for triggering a Traffic Volume Measurement (TVM) report. The Event 4a threshold is specified in the standard, and is used by the UE for triggering Traffic Volume Measurement Report, which summarizes the buffer occupancy of each uplink Radio Bearer.

Other parameters which are not defined in the standard are an uplink Event 4a threshold for triggering the state transition of a given UE to CELL_DCH state, and a downlink Event 4a threshold for triggering the state transition of the given UE to CELL_DCH state. As will be appreciated, the uplink and downlink Event 4a thresholds being ‘undefined’ in the standard means that the respective thresholds can vary from vendor to vendor, or from implementation to implementation at different RANs.

Referring to the uplink Event 4a threshold, in CELL_FACH state, if the reported uplink buffer occupancy of each Radio Bearer exceeds the uplink Event 4a threshold, the RNC 122 moves the UE to CELL_DCH. In an example, this decision may be made based on the aggregated buffer occupancy or individual Radio Bearer buffer occupancy. If aggregated buffer occupancy is used for deciding the CELL_DCH transition, the same threshold for triggering TVM can be used. Similarly, referring to the downlink Event 4a threshold, in CELL_FACH state, if the downlink buffer occupancy of the Radio Bearers of the UE exceeds the downlink Event 4a threshold, the RNC 122 moves the UE to CELL_DCH state. In an example, this decision may be done based on the aggregated buffer occupancy or individual Radio Bearer buffer occupancy.

Accordingly, the size of the call request message can determine whether the originating UE is transitioned to CELL_FACH state or CELL_DCH state. Specifically, one of the Event 4a thresholds is conventionally used to make the CELL_DCH state determination at the RAN 120. Thus, when the Event 4a threshold is exceeded, the RAN 120 triggers the CELL_DCH state transition of the UE.

However, the processing speed or responsiveness of the RAN 120 itself can also affect whether the CELL_DCH state or CELL_FACH state is a more efficient option for transmitting the call request message. For example, if the RAN 120 is capable of allocating DCH resources to an originating UE within 10 milliseconds (ms) after receiving a cell update message, the CELL_DCH state transition of the originating UE may be relatively fast so that transitions to DCH may be suitable for transmitting delay-sensitive call request messages. On the other hand, if the RAN 120 is capable of allocating DCH resources to an originating UE only after 100 milliseconds (ms) after receiving a cell update message, the CELL_DCH state transition of the originating UE may be relatively slow, so that the transmission of the call request message may actually be completed faster on the RACH.

As will be appreciated, the Event 4a threshold(s) are typically set high enough to achieve efficient resource utilization, as lower Event 4a thresholds will cause more frequent DCH resource allocations to UEs that do not necessarily require DCHs to complete their data exchange in a timely manner. However, it is possible that data transmissions that do not exceed the Event 4a threshold can be transmitted more quickly either in CELL_FACH state or CELL_DCH state based on the processing speed of the RAN 120 and the amount of data to be transmitted. However, as noted above, conventional RANs do not evaluate criteria aside from whether measured or reported traffic volume exceeds the Event 4a threshold(s) in making the CELL_DCH state transition determination.

In W-CDMA Rel. 6, a new feature referred to as a Traffic Volume Indicator (TVI) is introduced, whereby the originating UE has the option of including the TVI within the cell update message during a cell update procedure. The RAN 120 will interpret a cell update message including the TVI (i.e., TVI=True) as if the Event 4a threshold for triggering a TVM report was exceeded (i.e., in other words, as if the uplink traffic volume buffer occupancy exceeds the Event 4a threshold for triggering a TVM report), such that the RAN 120 will transition the originating UE directly to the CELL_DCH state. Alternatively, if the TVI is not included in the cell update message, the RAN 120 will only transition the originating UE to CELL_DCH state upon receipt of a Traffic Volume Measurement Report for Event 4a.

When a given UE performs a cell update procedure, the given UE can be attempting to transition into a target state (e.g., CELL_FACH state, CELL_DCH state, etc.) for supporting different types of communication sessions, including communication sessions arbitrated by the application server 170 (e.g., PTT, PTX, etc.). For example, the given UE can perform the cell update procedure so as to transition into a state whereby a call request message can be transmitted to the application server 170 to prompt the application server 170 to set-up a communication session between the given UE and one or more target UEs identified by the call request message. In this case, the type of communication session associated with the cell update procedure can be referred to as a direct packet-switched (PS) call or a direct call session.

Alternatively, in another example, the given UE can perform the cell update procedure so as to transition into a state whereby an ‘alert’ message, or an isolated message that is not a precursor to a direct PS call or direct call session, can be to the application server 170. For example, these types of alert messages can be one-way, one-time communication messages (except for potential re-transmissions of the alert messages and ACKs to the alert messages) that do not necessarily lead to subsequent messaging from the transmitting or originating UE. The application server 170 receives the alert message and then forwards the alert message to one or more target UEs identified by the alert message. In this case, the type of communication session associated with the cell update procedure can be referred to as an alert message or alert message session.

In other examples, the given UE can perform the cell update procedure so as to transition into a state whereby a circuit switched (CS) call can be made and/or a packet switched (PS) call (e.g., VoIP, etc.) that is arbitrated by some server other than the application server 170.

The operator of the RAN 120 may wish to log information associated with the types of communication sessions that result from cell update procedures on a sector by sector basis. For example, understanding the ratios of cell update procedures that culminate in CS calls, direct PS calls arbitrated by the application server 170, alert messages arbitrated by the applicant server 170 and/or PS calls arbitrated by some other server can help the operator of the RAN 120 to better understand the usage on the RAN 120 so as to better deploy resources.

Conventionally, the information that is gleaned by the RAN 120 from the cell update procedures is very limited and is insufficient to distinguish between the types of communication sessions within which a UE engaged in a cell update procedure will ultimately participate. For instance, the RAN 120 will not typically know that a UE performing a cell update procedure may wish to transition to CELL_DCH state for the purpose of initiating a delay-sensitive PTT session. The RAN 120 could rely upon the application server 170, for example, to notify the RAN 120 regarding the communication session types. However, the RAN 120 may have trouble tying the reported communication session types to specific sectors within the RAN 120 because the application server 170 is not necessarily aware of the locations of its UEs on a sector-level of precision.

Accordingly, embodiments of the invention are directed to an enhanced cell update procedure whereby information related to the type of communication session associated with the cell update procedure is conveyed from the UE to the RAN 120 during the cell update procedure. By determining the type (e.g., PS call arbitrated by the application server 170 or some other server, CS call, alert message arbitrated by the application server 170, etc.) during the cell update procedure, the RAN 120 is able to associate the type of communication session with which the UE is attempting to engage with the serving area (e.g., serving sector, etc.) of the UE. More specifically, as will be discussed in greater detail below, one or more fields (e.g., an Establishment Cause Field and/or the TVI field mentioned above) of the cell update message can be modified by the UE in certain situations to convey the communication session type information to the RAN 120.

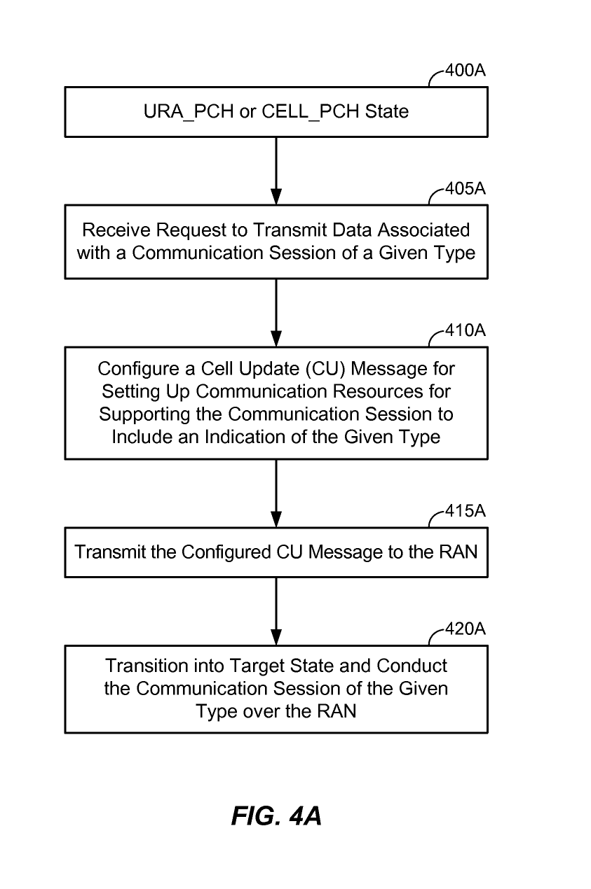

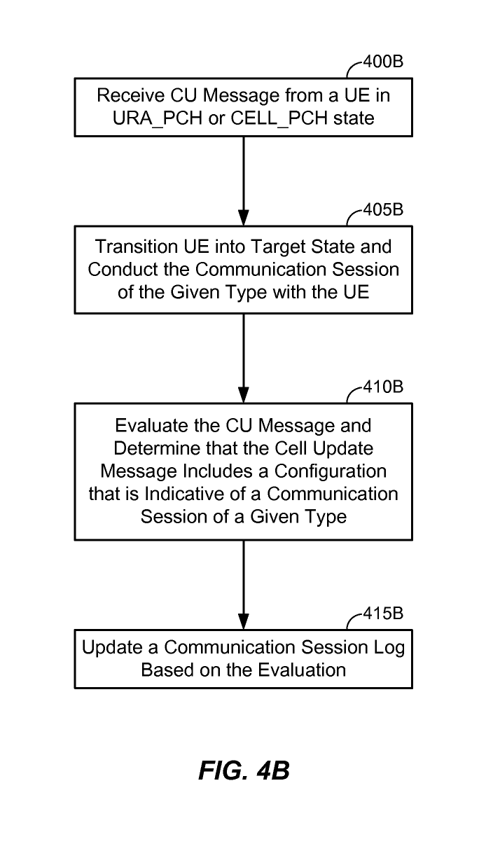

Below, the processes of FIGS. 4A through 8C are described as implemented within a Universal Mobile Telecommunications System (UMTS) that uses Wideband Code Division Multiple Access (W-CDMA) in accordance with embodiments of the invention. However, it will be appreciated by one of ordinary skill in the art how FIGS. 4A through 8C can be directed to communication sessions in accordance with protocols other than W-CDMA. Further, certain signaling messages referred to herein are described whereby the application server 170 corresponds to a PTT server. However, it will be appreciated that other embodiments can be directed to servers providing services other than PTT to UEs of the system 100 (e.g., push-to-transfer (PTX) services, VoIP services, group-text sessions, etc.).

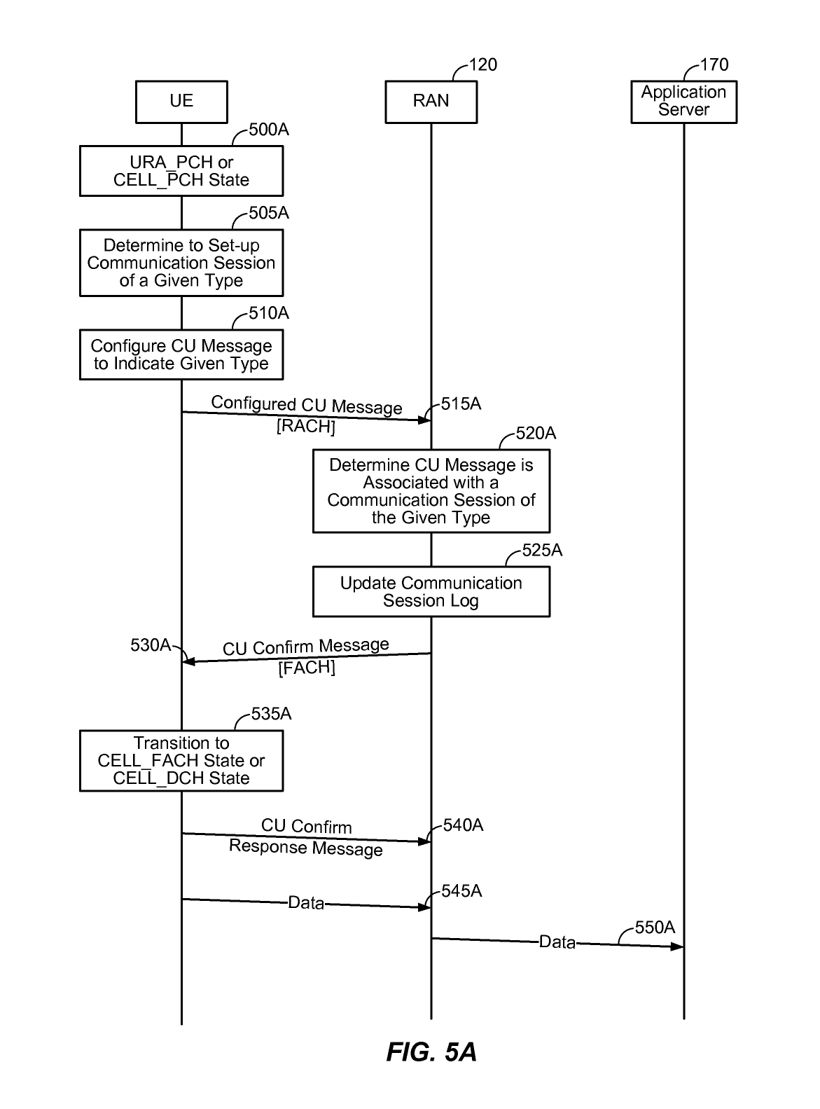

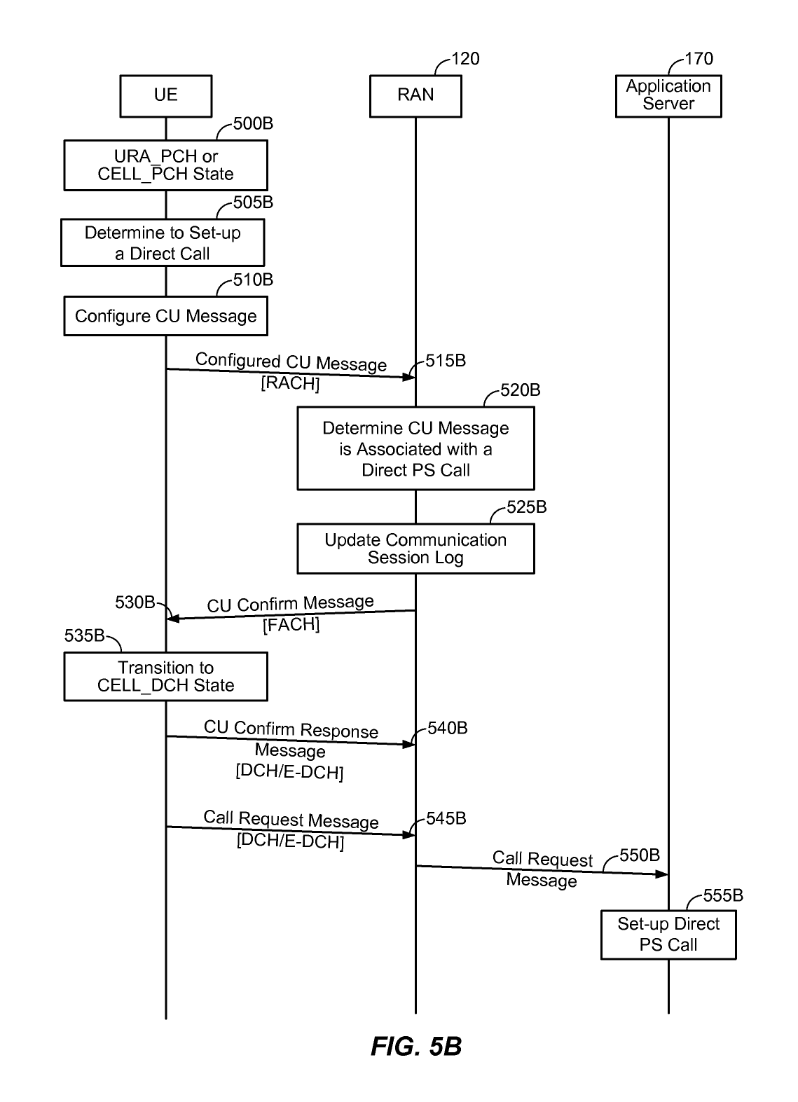

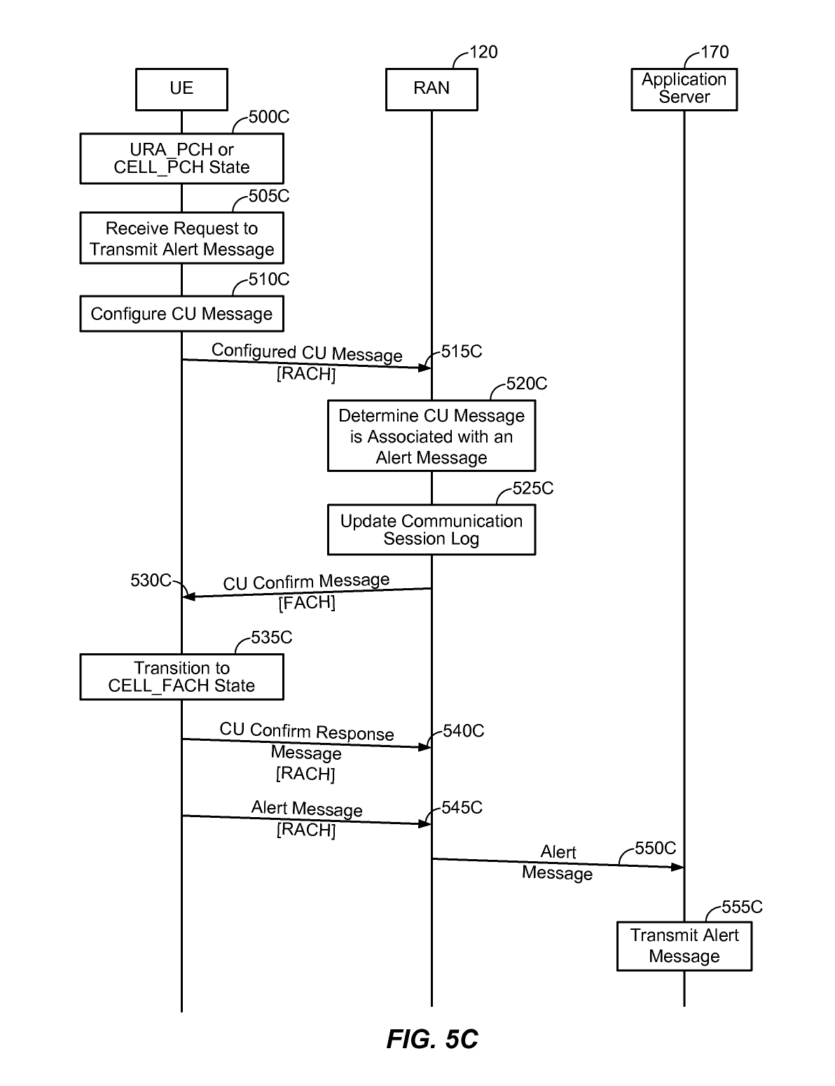

FIGS. 4A and 4B illustrate operation of the UE and the RAN 120, respectively, in accordance with embodiments of the invention. FIGS. 4A and 4B illustrate the respective operations of the UE and the RAN 120 at a high-level, with more detailed implementations discussed below with respect to FIG. 5A to FIG. 8C.

Referring to FIG. 4A, assume that a given UE (“originating UE”) is operating in either URA_PCH or CELL_PCH state, 400A. While in URA_PCH or CELL_PCH state, the originating UE receives a request to initiate a communication session of a given, 405A. For example, the received request of 405A can correspond to a multimedia client application or API being executed on the originating UE receiving an indication that a user of the originating UE has pushed a PTT button to initiate a PTT communication session (e.g., alert message or direct PS call) to be arbitrated by the application server 170. Alternatively, the received request of 405A can correspond to an indication that a user of the originating UE wants to engage in a CS call or a PS call to be arbitrated by a server other than the application server 170.

After received the request to initiate the communication session of the given type at 405A, the originating UE configures a cell update message for setting up communication resources (e.g., a request to obtain a C-RNTI and to transition to CELL_FACH state or CELL_DCH state) for supporting the communication session to further include an indication of the given type, 410A. As will be discussed in more detail below, the indication of the given type within the cell update message can be related to a specialized configuration or bit-setting of the TVI and/or Establishment Cause fields of the cell update message, specialized measurement control parameters and/or the inclusion or omission of an Initial Direct Transfer (IDT) message.

After configuring the cell update message in 410A, the originating UE transmits the configured cell update message on RACH to the RAN 120, 415A. The originating UE then transitions into the target state (e.g., CELL_DCH state or CELL_FACH state) and conducts the communication session of the given type (e.g., direct call session, alert message session, etc.) over the RAN 120 with the application server 170 using the acquired communication resources, 420A.

Turning to FIG. 4B, the RAN 120 receives a cell update message from the originating UE, 400B, and then transitions the originating UE into a target state (e.g., CELL_DCH state or CELL_FACH state, whereby the RAN 120 assigns a C-RNTI to the originating UE in conjunction with the state transition responsive to the cell update message) and conducts the communication session of the given type (e.g., direct call session, alert message session, etc.) between the originating UE and the application server 170, 405B. The RAN 120 also evaluates the cell update message to determine whether the cell update message includes a configuration that is indicative of a given type of communication session, 410B. In this instance, assume that the cell update message received at 400B is configured by the originating UE as discussed above with respect to 410A of FIG. 4A, such that the RAN 120 associates the received cell update message with the indicated type of communication session. The RAN 120 updates a communication session log that tracks the types of communication sessions initiated by UEs in particular serving areas (e.g., sectors), 415B.

FIG. 5A illustrates a more detailed implementation of FIGS. 4A and 4B in accordance with an embodiment of the invention. In particular, FIG. 5A illustrates an example whereby the communicate session being established is arbitrated by the application server 170 (not a CS call or a PS call arbitrated by some other server). Referring to FIG. 5A, 500A through 515A correspond to 400A through 415A of FIG. 4A. After the RAN 120 receives the configured cell update message in 515A, the RAN 120 determines that the cell update message includes an indication of a given type of communication session, 520A, and updates the communication session log accordingly, 525A.

The RAN 120 also responds to the configured cell update message from 515A with a cell update confirm message on the FACH, 530A. The cell update confirm message instructs the originating UE to transition into CELL_FACH state or CELL_DCH state (e.g., depending on an uplink TVM report, on whether TVI=TRUE in the cell update message from 515A, or other factors) and includes the C-RNTI assigned by the RAN 120 to the originating UE. The originating UE receives the cell update confirm message from the RAN 120 and then transitions into the target cell-state, 535A.

After completing the transition into the target cell-state (e.g., CELL_FACH state or CELL_DCH state), the originating UE transmits a cell update confirm response message to the RAN 120, 540A. For example, if the target state is CELL_FACH, the cell update confirm response message is transmitted to the RAN 120 on the RACH in 540A. Alternatively, if the target cell-state is CELL_DCH, the cell update confirm response message is transmitted to the RAN 120 on the DCH or E-DCH after a L1 synchronization procedure in 540A. The originating UE then transmits IP-layer data (e.g., an alert message, a call request message, etc.) to the RAN 120, 545A, which is forwarded by the RAN 120 to the application server 170, 550A.

FIG. 5B illustrates an example implementation of FIG. 5A where the given type of communication session being set-up corresponds to a direct call session to be arbitrated by the application server 170 in accordance with an embodiment of the invention and FIG. 5C illustrates another example implementation of FIG. 5A where the given type of communication session being set-up corresponds to an alert message session to be arbitrated by the application server 170 in accordance with another embodiment of the invention.

Thus, 500B through 550B of FIG. 5B substantially correspond to 500A through 550A of FIG. 5A, respectively, except that FIG. 5B is illustrated more specifically to the given type of the communication session being a direct call session. For example, 505B is shown as receiving a request to set-up a server-arbitrated direct PS call, and so on. After the application server 170 receives the call request message at 550B, the application server 170 sets up the direct call session between the originating UE and at least one target UE, 555B. For example, while not shown explicitly in FIG. 5B, the application server 170 can identify one or more target UEs based on the call request message and then announce the direct call session to the identified target UE(s) while waiting for at least one of the target UE(s) to accept the announced communication session.

Similarly, 500C through 550C of FIG. 5C substantially correspond to 500A through 550A of FIG. 5A, respectively, except that FIG. 5C is illustrated more specifically to the given type of the communication session being an alert message session. For example, 505C is shown as receiving a request to transmit a server-arbitrated alert message, and so on. After the application server 170 receives the alert message at 550C, the application server 170 transmits the alert message to at least one target UE, 555C. For example, while not shown explicitly in FIG. 5C, the application server 170 can identify one or more target UEs based on the alert message and then transmit the alert message to the identified target UE(s).

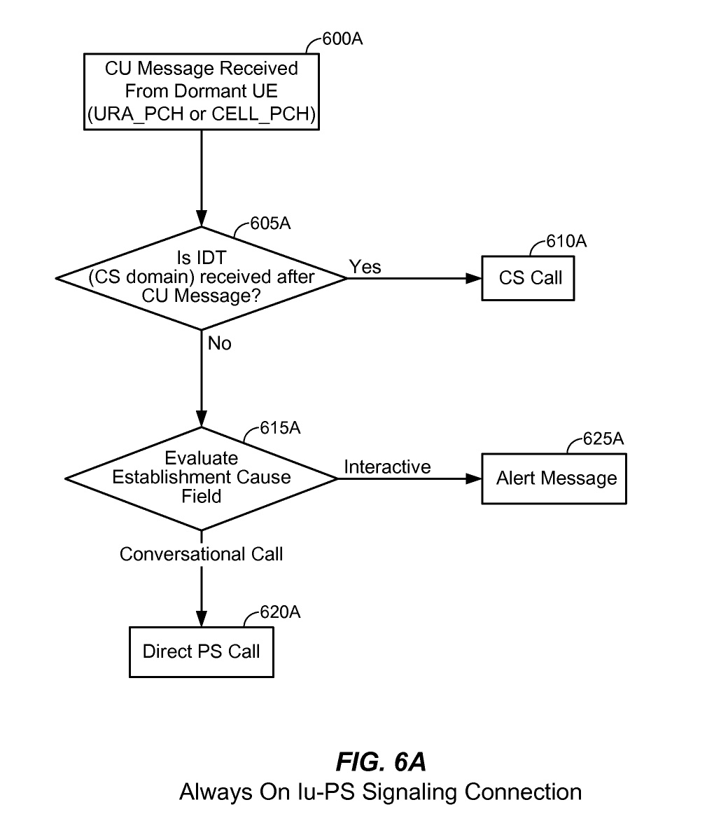

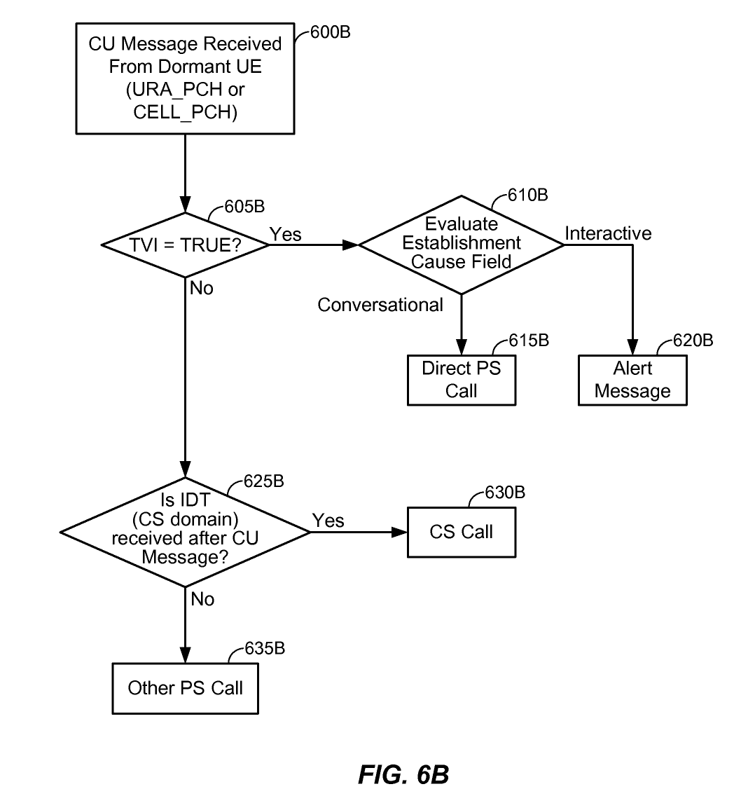

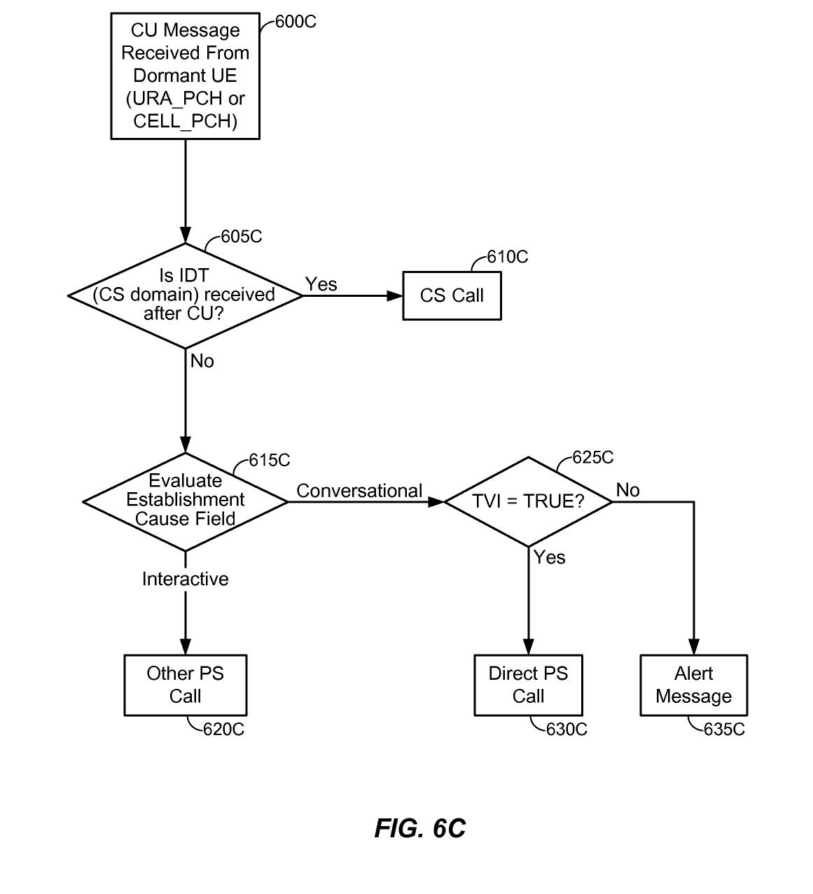

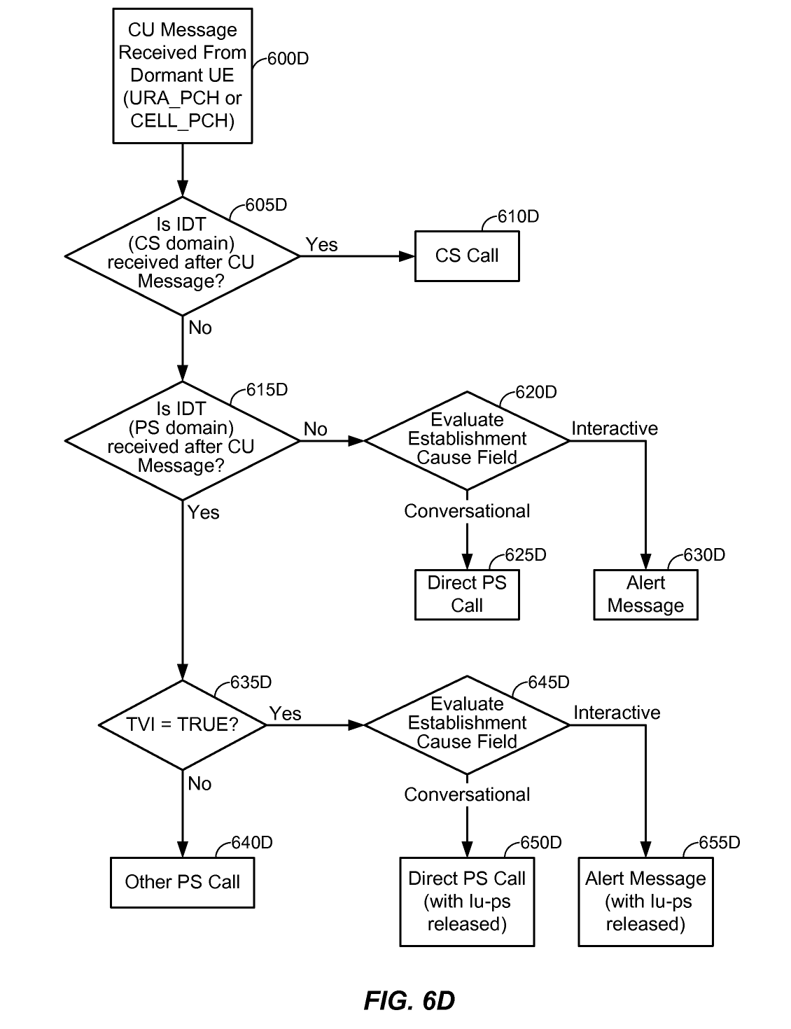

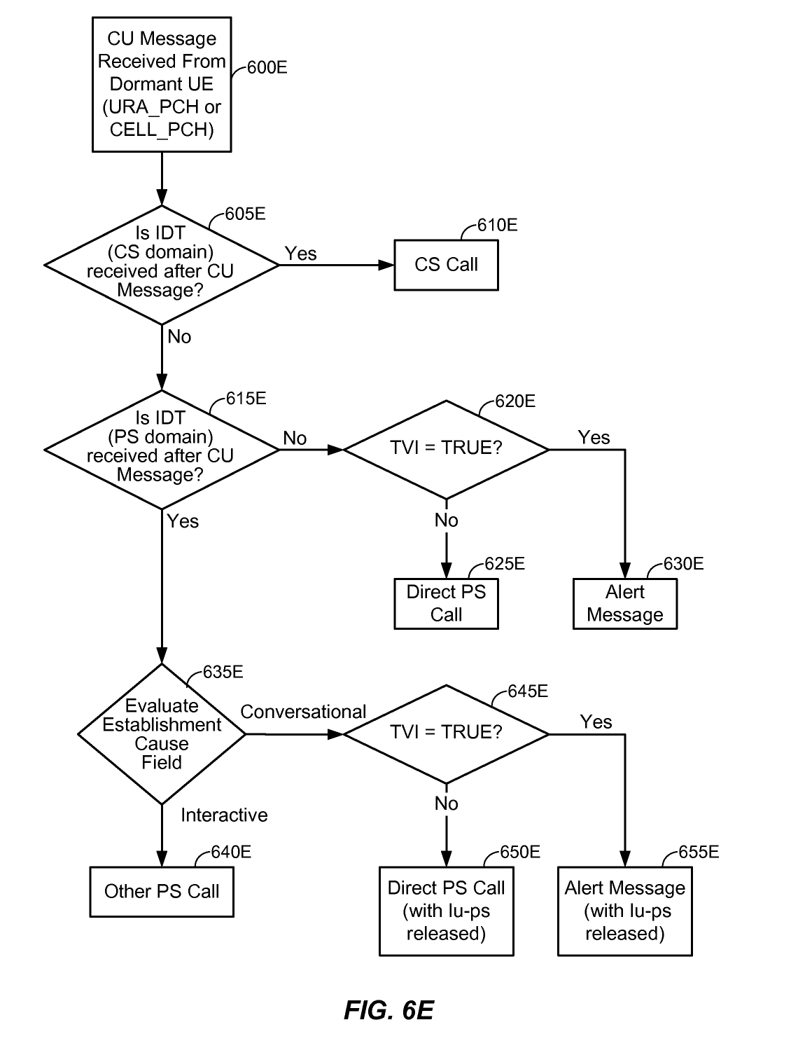

In the description of FIGS. 4A through 5C, the manner in which the originating UE configures the cell update message to indicate the given type of the communication session and the manner in which the RAN 120 evaluates the configuration of the cell update message to determine the indicated type of the communication session is described at a relatively high level. Lower level implementations of these actions in different operating scenarios will now be described with respect to FIGS. 6A through 8C.

To better understand the description below, a brief discussion of a relevant portion of the W-CDMA standard will be discussed at this point. Current W-CDMA standards only require UEs to include an Establishment Cause in the Establishment Cause field of the cell update message when an Initial Direct Transfer (IDT) message is transmitted, where the IDT message is associated with setting up an Iu-PS signaling connection between the RAN 120 and the core network or carrier network 126. Thus, unless the UE is required to transmit the IDT in conjunction with the cell update procedure, the Establishment Cause field is optional.

Further, certain delay-sensitive multimedia applications (e.g., PTT, etc.) can maintain an always-on or constant Iu-PS signaling connection for UEs in CELL_PCH or URA_PCH states. This is relevant here because if a UE already has an active Iu-PS signaling connection, the IDT does not need to be sent which essentially frees-up the Establishment Cause field of the cell update message. Thus, under the assumption that the Iu-PS signaling connection for a dormant UE (i.e., a UE in CELL_PCH or URA_PCH state) is always-on, the UE can be configured to refrain from sending any IDTs during the cell update procedure so that the Establishment Cause field of the cell update message can be used to indicate other information, such as whether the type of communication session to be established corresponds to a direct call session or alert message session to be arbitrated by the application server 170. Also, if the IDT is transmitted, other session-type information can be inferred. For example, if the originating UE transmits an IDT in the CS domain, the RAN 120 knows that the originating UE is in the process of setting up a CS call.

It is also possible certain RAN implementations will prohibit always-on Iu PS signaling connections, such that the originating UE will send an IDT in conjunction with any cell update procedures when the originating UE is in CELL_PCH or URA_PCH state. In this case, the TVI field can be leveraged as a secondary indicator of whether the Establishment Cause field contains session-type information. For example, if the RAN 120 receives an IDT for the PS domain after a cell update message and TVI=TRUE, then the RAN 120 will assume that the communication session being set-up is associated with a communication session to be arbitrated by the application server 170 and that the Establishment Cause field contains information indicative of the session-type. Otherwise, if the RAN 120 receives an IDT for the PS domain after a cell update message and TVI=FALSE, then the RAN 120 will assume that the communication session being set-up is not associated with a communication session to be arbitrated by the application server 170 and that the Establishment Cause field does not contain information indicative of the session-type.

Table 1 (below) illustrates the example configuration of the TVI and Establishment Cause fields of the cell update message as described above. Also shown in Table 1 is an indication of whether an IDT is transmitted along with the cell update message in the CS or PS domains during the cell update procedure for transitioning the UE from URA_PCH or CELL_PCH state into CELL_FACH state or CELL_DCH state.

TABLE 1

| | | | Cell Update Fields | |
|---|---|---|---|---|
| | | | | Establishment |
| Call Type | Domain | IDT? | TVI | Cause |
| Direct PS Call Arbitrated by | PS | NO | N/A | “Originating |
| Application Server 170 (RAN | | | | Conversational |
| supports always-on Iu-PS) | | | | Call” |
| Direct PS Call Arbitrated by | PS | YES | TRUE | “Originating |
| Application Server 170 (RAN | | | | Conversational |
| does not support always- | | | | Call” |
| on Iu-PS) | | | | |
| Direct PS Call Arbitrated by | PS | NO | TRUE | “Originating |
| Application Server 170 (RAN | | | | Conversational |
| does not support always-on | | | | Call” |
| Iu-PS) | | | | |
| Alert Message Arbitrated by | PS | NO | N/A | “Interactive” |
| Application Server 170 (RAN | | | | |
| supports always-on Iu-PS) | | | | |
| Alert Message Arbitrated by | PS | YES | TRUE | “Interactive” |
| Application Server 170 (RAN | | | | |
| does not support always-on | | | | |
| Iu-PS) | | | | |
| Alert Message Arbitrated by | PS | NO | FALSE | “Originating |
| Application Server 170 (RAN | | | | Conversational |
| supports always-on Iu-PS) | | | | Call” |
| PS Call Arbitrated by Some | PS | YES | FALSE | N/A |
| Other Server | | | | |
| PS Call Arbitrated by Some | PS | NO | N/A | “Interactive” |
| Other Server | | | | |
| CS Call | CS | YES | N/A | N/A |

Referring to the example of Table 1 (above), a direct PS call to be arbitrated by the application server 170 may be indicated in an implementation where the RAN 120 supports the always-on Iu-PS signaling connection for the originating UE by omitting the IDT and setting the Establishment Cause field of the cell update message to an “Originating Conversational Call” setting. Also, a direct PS call to be arbitrated by the application server 170 may be indicated in an implementation where the RAN 120 does not support the always-on Iu-PS signaling connection for the originating UE by including the IDT, setting TVI=TRUE and further setting the Establishment Cause field of the cell update message to the “Originating Conversational Call” setting.

Referring to the example of Table 1 (above), an alert message to be arbitrated by the application server 170 may be indicated in an implementation where the RAN 120 supports the always-on Iu-PS signaling connection for the originating UE by omitting the IDT and setting the Establishment Cause field of the cell update message to an “Interactive” setting. Also, an alert message to be arbitrated by the application server 170 may be indicated in an implementation where the RAN 120 does not support the always-on Iu-PS signaling connection for the originating UE by including the IDT, setting TVI=TRUE and further setting the Establishment Cause field of the cell update message to the “Interactive” setting.

Further, still referring to the example of Table 1 (above), a PS call to be arbitrated by some server other than the application server 170 may be indicated, irrespective of whether the RAN 120 supports the always-on Iu-PS signaling connection for the originating UE, by including the IDT and setting TVI=FALSE. Further, still referring to the example of Table 1 (above), a CS call can be indicated simply by including the IDT in association with the CS domain, because the application server 170 arbitrates communications over the PS domain.

Referring to Table 1 (above), the examples where the TVI field is used to distinguish between PS sessions that are arbitrated by the application server 170 and PS sessions that are not arbitrated by the application server 170 is based on a specialized TVI protocol that attempts to ensure that TVI=FALSE for all sessions except the sessions to be arbitrated by the application server 170. This can be accomplished in a variety of ways. For example, the RAN 120 (e.g., a RNC at the RAN 120) can configure the measurement control or TVM parameters such that either “event 4a threshold !=4” or “measurement validity !=All state except CELL_DCH”. In this case, TVI=TRUE will not occur in the cell update message during normal operation and instead can be used to indicate traffic associated with communication sessions to be arbitrated by the application server 170. In another example, the RAN 120 (e.g., a RNC at the RAN 120) can configure the measurement control or TVM parameters such that event 4a threshold is large enough so that no IDT carrying NAS messages (e.g. Service Request, PDP Context Activation, etc.) can trigger TVI=TRUE in the cell update message. Accordingly, in this alternate scenario, TVI=TRUE will not occur in the cell update message during normal operation and instead can be used to indicate traffic associated with communication sessions to be arbitrated by the application server 170. Accordingly, TVI=TRUE may be used even when IDT messages are transmitted to function to flag sessions that are arbitrated by the application server 170.

FIGS. 6A through 6E illustrate example implementations of cell update message evaluation logic that can be provisioned at, or executed by, the RAN 120 to determine a session-type associated with a received cell update message for a dormant UE (e.g., a UE in CELL_PCH or URA_PCH state). Specifically, each of FIGS. 6A through 6E substantially correspond to an example implementation of 410B of FIG. 4B, 520A of FIG. 5A, 520B of FIG. 5B and/or 520C of FIG. 5C. Also, the processes of FIGS. 6A through 6E are based on the example session-type indication rules described above with respect to Table 1.

Referring to FIG. 6A, assume that the RAN 120 supports an always-on Iu-PS signaling connection for a dormant UE. While the always-on Iu-PS signaling connection is maintained, a cell update message is received at the RAN 120 from the dormant UE (e.g., a UE in CELL_PCH or URA_PCH state), 600A. For example, 600A can correspond to 400B of FIG. 4B, 515A of FIG. 5A, 515B or of FIG. 5B and/or 515C of FIG. 5C. Next, the RAN 120 determines whether an IDT is received for the CS domain after the cell update message of 600A, 605A. If an IDT is determined to be received for the CS domain after the cell update message, then the RAN 120 determines that the communication session being established in association with the cell update procedure corresponds to a CS call, 610A. Otherwise, if an IDT is determined not to be received for the CS domain after the cell update message, the RAN 120 evaluates the Establishment Cause field of the cell update message in 615A. In 615A, if the RAN 120 determines that the Establishment Cause field is configured to indicate “Originating Conversational Call”, then the RAN 120 determines the communication session being established in association with the cell update procedure corresponds to a direct PS call arbitrated by the application server 170, 620A. Otherwise, in 615A, if the RAN 120 determines that the Establishment Cause field is configured to indicate “Interactive”, then the RAN 120 determines the communication session being established in association with the cell update procedure corresponds to an alert message to be arbitrated by the application server 170, 625A. In FIG. 6A, because the RAN 120 is assumed to support the always-on Iu-PS signaling connection for the dormant UE, the specialized TVI protocol need not be implemented, as shown in Table 1 (Above), such that FIG. 6A may be implemented in RANs that support releases earlier than Rel. 6.

Referring to FIG. 6B, the process of FIG. 6B can be implemented to determine the session-type irrespective of whether the RAN 120 supports an always-on Iu-PS signaling connection for a dormant UE. FIG. 6B is described under the assumption that the specialized TVI and TVM protocols discussed above are implemented such that TVI=TRUE can be used to infer that the cell update message is associated with set-up of a communication session to be arbitrated by the application server 170. Accordingly, a cell update message is received at the RAN 120 from the dormant UE (e.g., a UE in CELL_PCH or URA_PCH state), 600B. For example, 600B can correspond to 400B of FIG. 4B, 515A of FIG. 5A, 515B or of FIG. 5B and/or 515C of FIG. 5C. Next, the RAN 120 determines whether TVI=TRUE within the cell update message, 605B. If the RAN determines TVI=TRUE, then the RAN 120 may evaluate the Establishment Cause field in 610B through 620B in a similar manner as in 615A through 625A of FIG. 6A, respectively. Otherwise, if the RAN 120 determines TVI=FALSE, the RAN 120 determines whether an IDT is received in the CS domain after the cell update message of 600B, 625B (e.g., similar to 605A of FIG. 6A). If an IDT is determined to be received in the CS domain after the cell update message, then the RAN 120 determines that the communication session being established in association with the cell update procedure corresponds to a CS call, 630B. Otherwise, if an IDT is determined not to be received in the CS domain after the cell update message, the RAN 120 determines the communication session being established in association with the cell update procedure corresponds to a PS call arbitrated by some server other than the application server 170, 635B.

Referring to FIG. 6C, the process of FIG. 6C can be implemented to determine the session-type irrespective of whether the RAN 120 supports an always-on Iu-PS signaling connection for a dormant UE. FIG. 6C relates to a slightly different specialized TVI protocol than FIG. 6B. In FIG. 6B, the TVI field is used to indicate whether or not the cell update procedure is associated with a session to be arbitrated by the application server 170 and the Establishment Cause field is used to indicate the particular session-type. In FIG. 6C, these operations are reversed in the sense that the Establishment Cause field is used to indicate whether or not the cell update procedure is associated with a session to be arbitrated by the application server 170 and the TVI field is used to indicate the particular session-type. Accordingly, 600C through 610C correspond to 600A through 610A of FIG. 6A, respectively. Next, the RAN 120 evaluates the Establishment Cause field of the cell update message, 615C. If the Establishment Cause field indicates “Interactive” in 615C, the RAN 120 determines the communication session being established in association with the cell update procedure corresponds to a PS Call arbitrated by some server other than the application server 170, 625C. Otherwise, if the Establishment Cause field indicates “Originating Conversational Call” in 615C, the RAN 120 determines the communication session being established in association with the cell update procedure corresponds to a session to be arbitrated by the application server 170, and the RAN 120 next evaluates whether TVI=TRUE, 625C. If the RAN 120 determines that TVI=TRUE in 625C, the RAN 120 determines that the communication session being established in association with the cell update procedure corresponds to a direct PS call to be arbitrated by the application server 170, 630C. Otherwise, if the RAN 120 determines that TVI=FALSE in 625C, the RAN 120 determines that the communication session being established in association with the cell update procedure corresponds to an alert message to be arbitrated by the application server 170, 635C.

Referring to FIG. 6D, the process of FIG. 6D can be implemented to determine the session-type irrespective of whether the RAN 120 supports an always-on Iu-PS signaling connection for a dormant UE. FIG. 6D is described under the assumption that the specialized TVI protocols are implemented such that, if necessary, TVI=TRUE can be used to infer that the cell update message is associated with set-up of a communication session to be arbitrated by the application server 170. Accordingly, 600D through 610D correspond to 600A through 610A of FIG. 6A, respectively. Next, the RAN 120 determines whether an IDT is received in the PS domain after the cell update message of 600D, 615D. If not, the RAN 120 knows that the cell update message is associated with a session to be arbitrated by the application server 170 and evaluates the Establishment Cause field of the cell update message, 620D. In 620D, if the RAN 120 determines that the Establishment Cause field indicates “Originating Conversational Call”, the RAN 120 determines that the cell update procedure is associated with a direct PS call to be arbitrated by the application server 170, 625D. Otherwise, in 620D, if the RAN 120 determines that the Establishment Cause field is configured to indicate “Interactive”, then the RAN 120 determines the communication session being established in association with the cell update procedure corresponds to an alert message to be arbitrated by the application server 170, 630D.

Referring to FIG. 6D, if an IDT is determined to be received in the PS domain after the cell update message in 615D, the RAN 120 checks whether TVI=TRUE to determine whether the cell update message is associated with a session to be arbitrated by the application server 170 or some other server, 635D. If TVI=FALSE, the RAN 120 determines the cell update message to be associated with a PS call to be arbitrated by some other server, 640D. Otherwise, if TVI=TRUE, the RAN 120 determines the cell update message to be associated with a session to be arbitrated by the application server 170, after which the Establishment Cause field of the cell update message can be used to determine the type of session in 645D through 655D as in 620D through 630D, respectively.

FIG. 6E illustrates decision logic that is similar to FIG. 6D, with 600E through 615E of FIG. 6E substantially corresponding to 600D through 615D of FIG. 6D. However, in FIG. 6E, the TVI field is evaluated at 620E and 645E instead of the Establishment Cause field at 620D and 645D, and the Establishment Cause field is evaluated at 635E instead of the TVI field at 635D. Accordingly, FIG. 6E illustrates another example that shows the various parameters of the cell update message (e.g., the Establishment Cause field, the TVI field, whether or not the cell update message is transmitted in conjunction with an IDT in the PS and/or CS domains, etc.) can be used in a number of different permutations to indication session information.

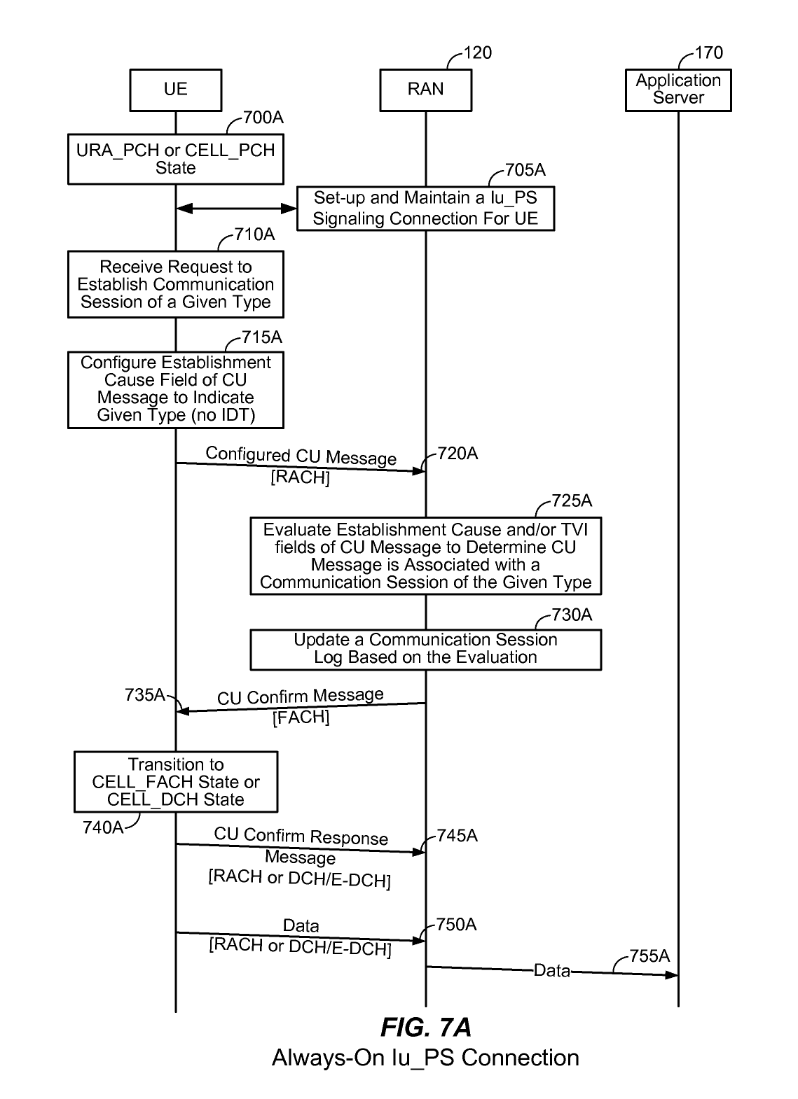

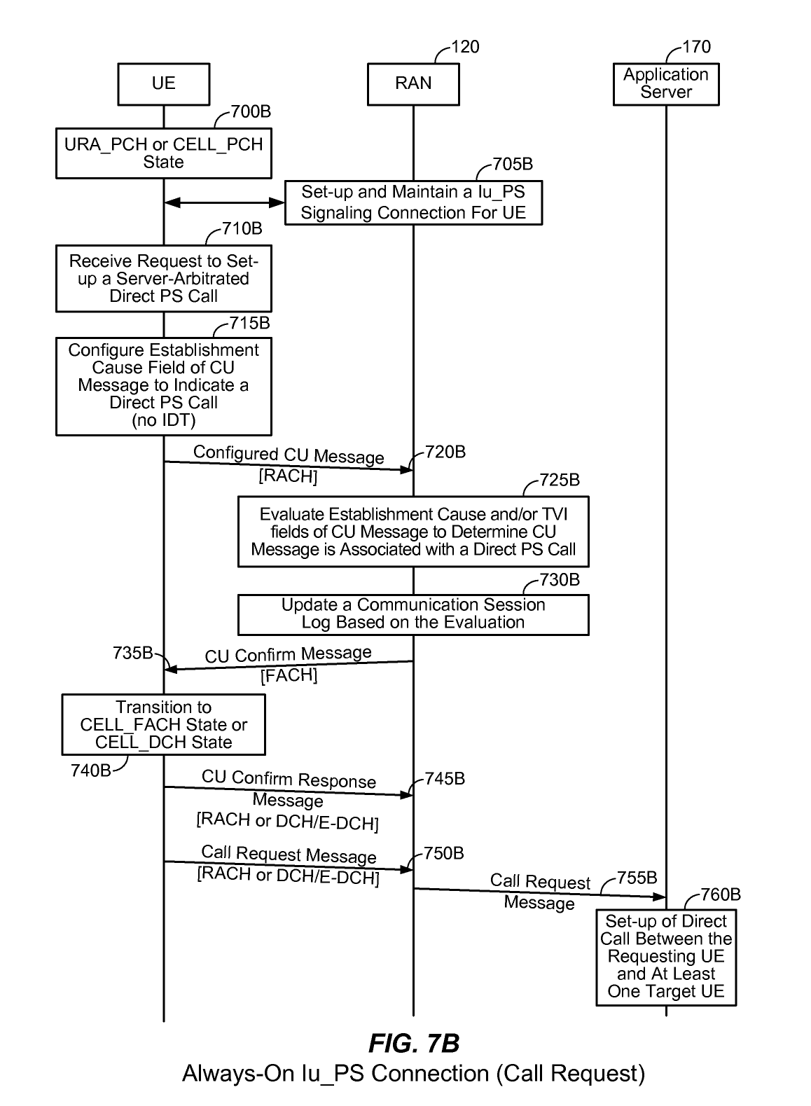

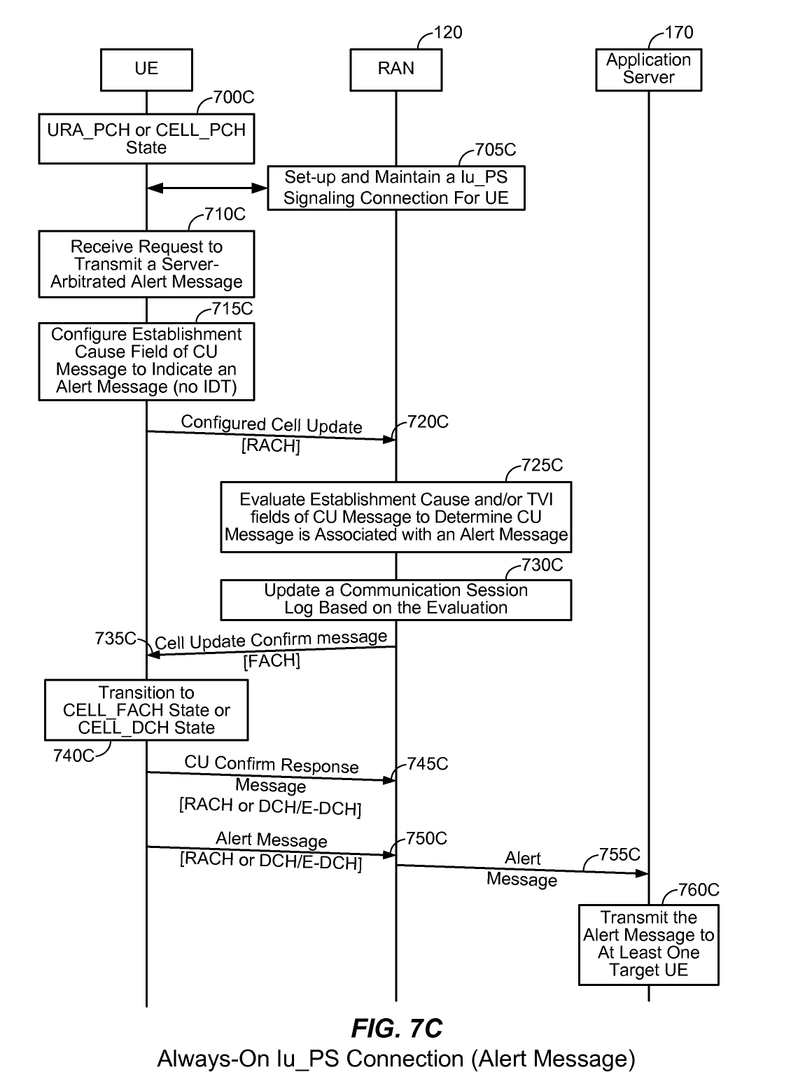

FIG. 7A is directed to an example implementation of FIG. 5A in accordance with the session-type evaluation logic of any of FIGS. 6A through 6E in a scenario whereby the RAN 120 maintains an always-on Iu-PS signaling connection for the originating UE in accordance with an embodiment of the invention.

Referring to FIG. 7A, assume that a given UE (“originating UE”) is operating in either URA_PCH or CELL_PCH state, 700A. Next, the RAN 120 sets up and maintains an Iu-PS signaling connection for the originating UE, 705A. In an example, the Iu-PS signaling connection may be configured to support sessions arbitrated by the application server 170 for the originating UE. Next, 710A through 755A substantially correspond to 505A through 550A of FIG. 5A. However, in 725A of FIG. 7A, the RAN 120 more specifically determines the given type of the communication session associated with the cell update procedure based on the Establishment Cause and/or TVI fields of the cell update message. For example, under the assumption that the communication session being established in FIG. 7A is to be arbitrated by the application server 170, the type of communication session may be determined based on the Establishment Cause field and the absence of an IDT in the CS domain (e.g., as in FIG. 6A), based on a combination of the Establishment Cause and TVI fields (e.g., as in FIG. 6B), based on the Establishment Cause and TVI fields and the absence of an IDT in the CS domain (e.g., as in FIG. 6C), based on the omission of an IDT in the CS or PS domains and the Establishment Cause field (e.g., 615D through 630D of FIG. 6D) and/or based on the omission of an IDT in the CS domain, reception of an IDT in the PS domain and the Establishment Cause and TVI fields (e.g., 615D and 635D through 655D of FIG. 6D, and also 615E and 635E through 655E of FIG. 6E).

FIG. 7B illustrates an example implementation of FIG. 7A where the given type of communication session being set-up corresponds to a direct call session to be arbitrated by the application server 170 in accordance with an embodiment of the invention and FIG. 7C illustrates another example implementation of FIG. 7A where the given type of communication session being set-up corresponds to an alert message session to be arbitrated by the application server 170 in accordance with another embodiment of the invention.

Referring to FIG. 7B, 700B through 755B of FIG. 5B substantially correspond to 700A through 755A of FIG. 7A, respectively, except that FIG. 7B is illustrated more specifically to the given type of the communication session being a direct call session. For example, 710B is shown as receiving a request to set-up a server-arbitrated direct PS call, and so on. After the application server 170 receives the call request message at 755B, the application server 170 sets up the direct call session between the originating UE and at least one target UE, 760B. For example, while not shown explicitly in FIG. 7B, the application server 170 can identify one or more target UEs based on the call request message and then announce the direct call session to the identified target UE(s) while waiting for at least one of the target UE(s) to accept the announced communication session. Also, the decision logic executed by the RAN 120 at 725B may be specific to the direct PS call determination for scenarios where the Iu-PS signaling connection is maintained for dormant UEs (e.g., as in 620A of FIG. 6A, 615B of FIG. 6B, 630C of FIG. 6C, 625D of FIG. 6D, 650D of FIG. 6D, 625E of FIG. 6E and/or 650E of FIG. 6E).

Similarly, referring to FIG. 7C, 700C through 755C of FIG. 7C substantially correspond to 700A through 755A of FIG. 7A, respectively, except that FIG. 7C is illustrated more specifically to the given type of the communication session being an alert message session. For example, 710C is shown as receiving a request to transmit a server-arbitrated alert message, and so on. After the application server 170 receives the alert message at 755C, the application server 170 transmits the alert message to at least one target UE, 760C. For example, while not shown explicitly in FIG. 7C, the application server 170 can identify one or more target UEs based on the alert message and then transmit the alert message to the target UE(s). Also, the decision logic executed by the RAN 120 at 725C may be specific to the alert message determination for scenarios where the Iu-PS signaling connection is maintained for dormant UEs (e.g., as in 625A of FIG. 6A, 620B of FIG. 6B, 635C of FIG. 6C, 630D of FIG. 6D and/or 655D of FIG. 6D).

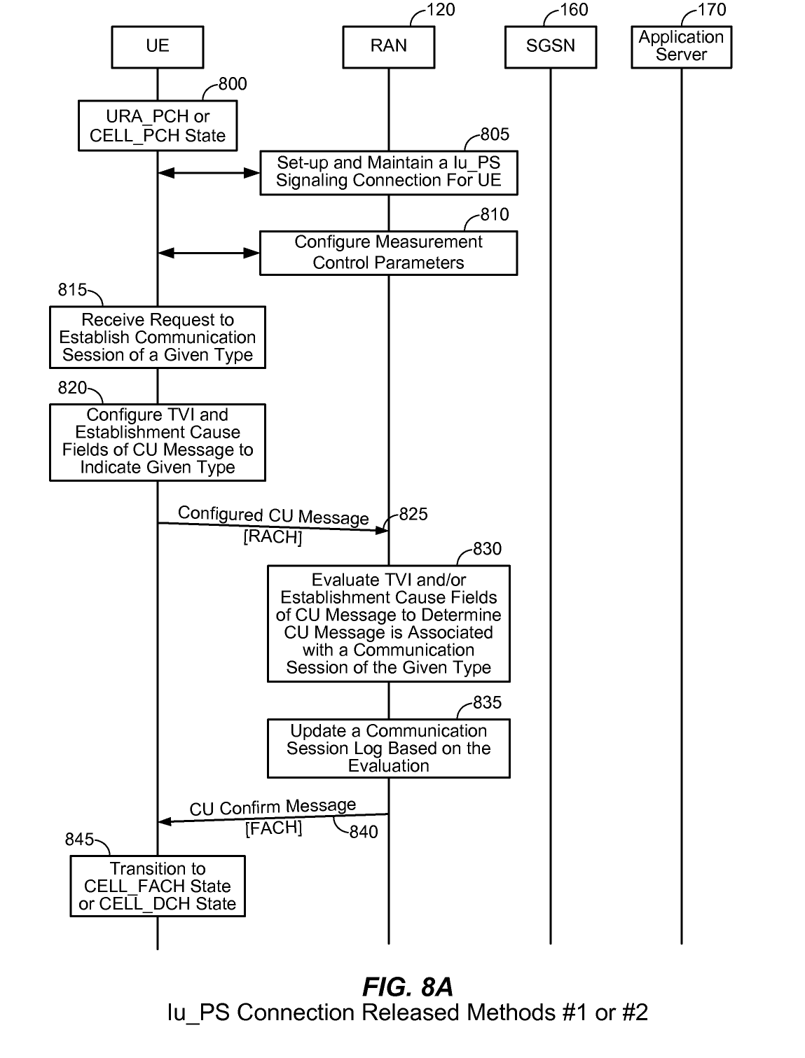

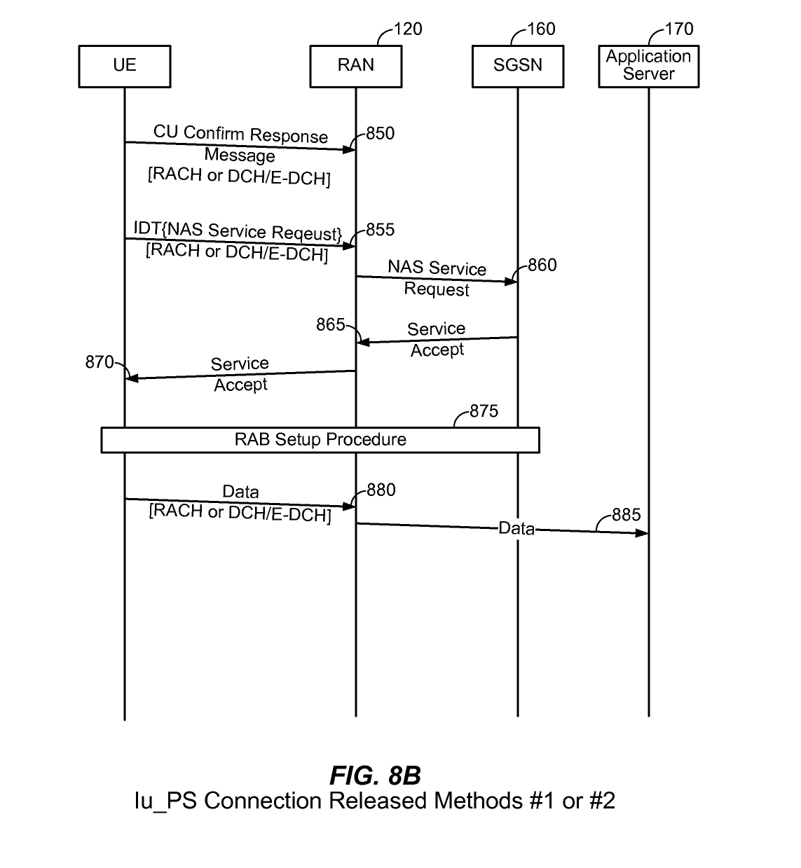

FIGS. 8A-8B are directed to an example implementation of FIG. 5A in accordance with the session-type evaluation logic of any of FIGS. 6B through 6E in a scenario whereby the RAN 120 does not maintain an always-on Iu-PS signaling connection for the originating UE in accordance with embodiments of the invention.

Referring to FIGS. 8A-8B, assume that a given UE (“originating UE”) is operating in either URA_PCH or CELL_PCH state, 800. Next, unlike FIG. 7A, the RAN 120 does not set-up or maintain an Iu-PS signaling connection for the originating UE, 805. Instead, in 810, the RAN 120 establishes measurement control or TVM parameters such that the configurations of the TVI field and/or the Establishment Cause field configuration of cell update messages can be used to indicate whether a particular cell update procedure is associated with a session to be arbitrated by the application server 170 and/or a type of the session.

For example, in 810, the RAN 120 (e.g., a RNC at the RAN 120) can configure the measurement control or TVM parameters so that either “event 4a threshold !=4” or “measurement validity !=All state except CELL_DCH”. In this case, TVI=TRUE will not occur in the cell update message during normal operation and instead can be used to indicate traffic associated with communication sessions to be arbitrated by the application server 170. In another example, in 810, the RAN 120 (e.g., a RNC at the RAN 120) can configure the measurement control or TVM parameters so that event 4a threshold is large enough so that no IDT carrying NAS messages (e.g. Service Request, PDP Context Activation, etc.) can trigger TVI=TRUE in the cell update message. Accordingly, in this alternate scenario, TVI=TRUE will not occur in the cell update message during normal operation and instead can be used to indicate traffic associated with communication sessions to be arbitrated by the application server 170. In either scenario, FIGS. 6B, 6C and/or 6D may use the above-noted specialized measurement control or TVM settings so that the TVI and/or Establishment Cause fields can flag sessions that are arbitrated by the application server 170.

Next, 815 through 850 substantially correspond to 505A through 540A of FIG. 5A. However, in 830 of FIG. 8A, the RAN 120 more specifically determines the given type of the communication session associated with the cell update procedure based on the Establishment Cause and/or TVI fields of the cell update message. For example, under the assumption that the communication session being established in FIGS. 8A-8B is to be arbitrated by the application server 170, the type of communication session may be determined based on the TVI field and the Establishment Cause field (e.g., as in FIG. 6B), based on the Establishment Cause and TVI fields and the absence of an IDT in the CS domain (e.g., as in FIG. 6C) and/or based on the omission of an IDT in the CS domain, reception of an IDT in the PS domain and the Establishment Cause and TVI fields (e.g., 615D and 635D through 655D of FIG. 6D, and also 615E and 635E through 655E of FIG. 6E).

Referring to FIGS. 8A-8B, after transmitting the cell update confirm response message to the RAN 120 in 850, the originating UE transmits an IDT {NAS Service Request} to the RAN 120, 855, and the RAN 120 forwards the NAS Service Request to the SGSN 160, 860. The SGSN 160 accepts the NAS Service Request and responds with a Service Accept message, 865, which is transmitted by the RAN 120 to the originating UE, 870. After the Service Accept message is sent to the originating UE, the originating UE, the RAN 120 and the SGSN 160 engage in a radio bearer (RAB) set-up procedure for the communication session, 875. After the RAB is established, the originating UE then transmits IP-layer data (e.g., an alert message, a call request message, etc.) to the RAN 120, 880, which is forwarded by the RAN 120 to the application server 170, 885.

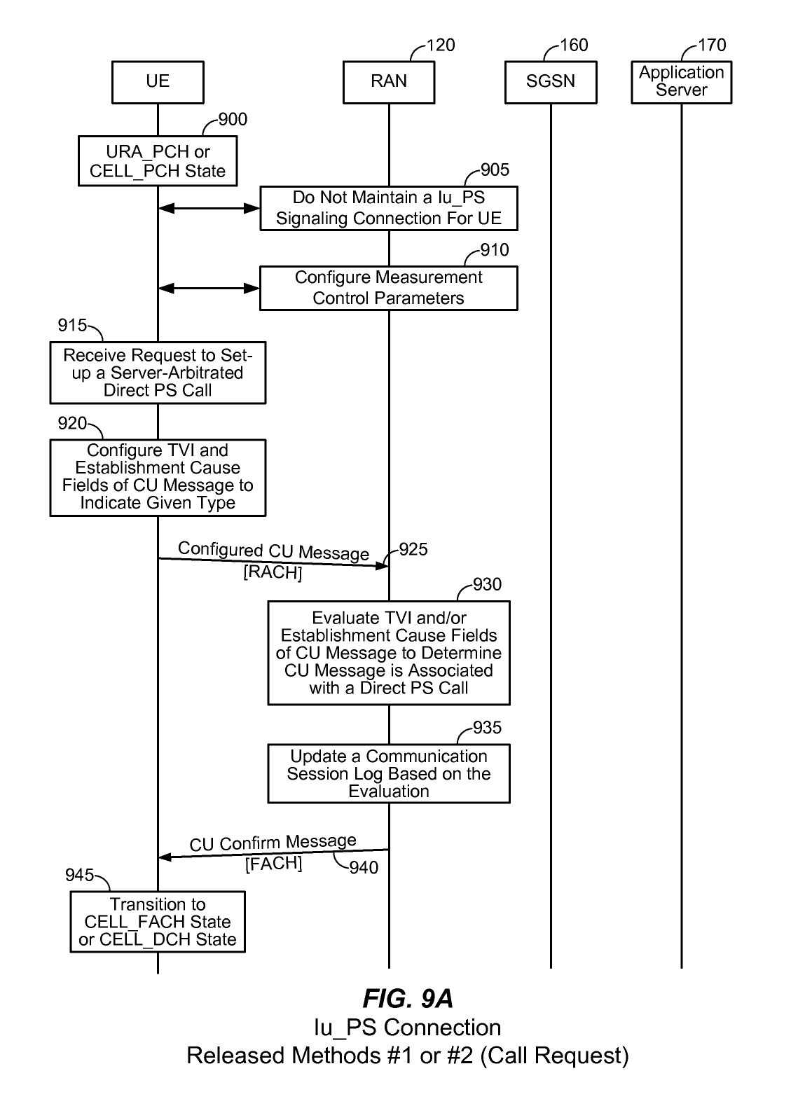

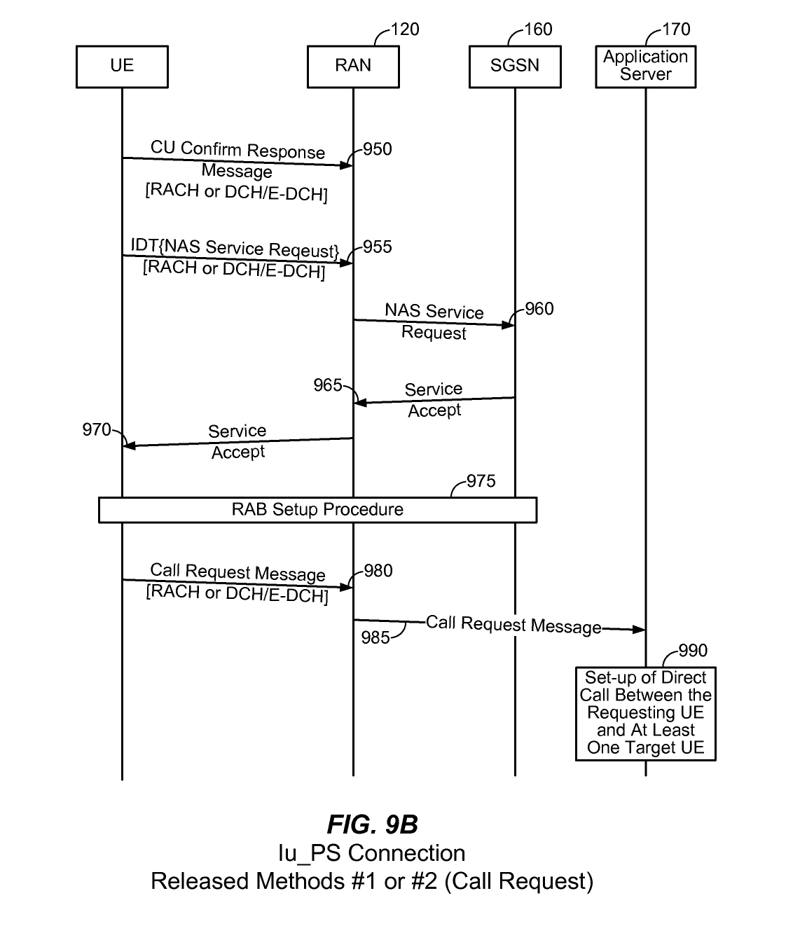

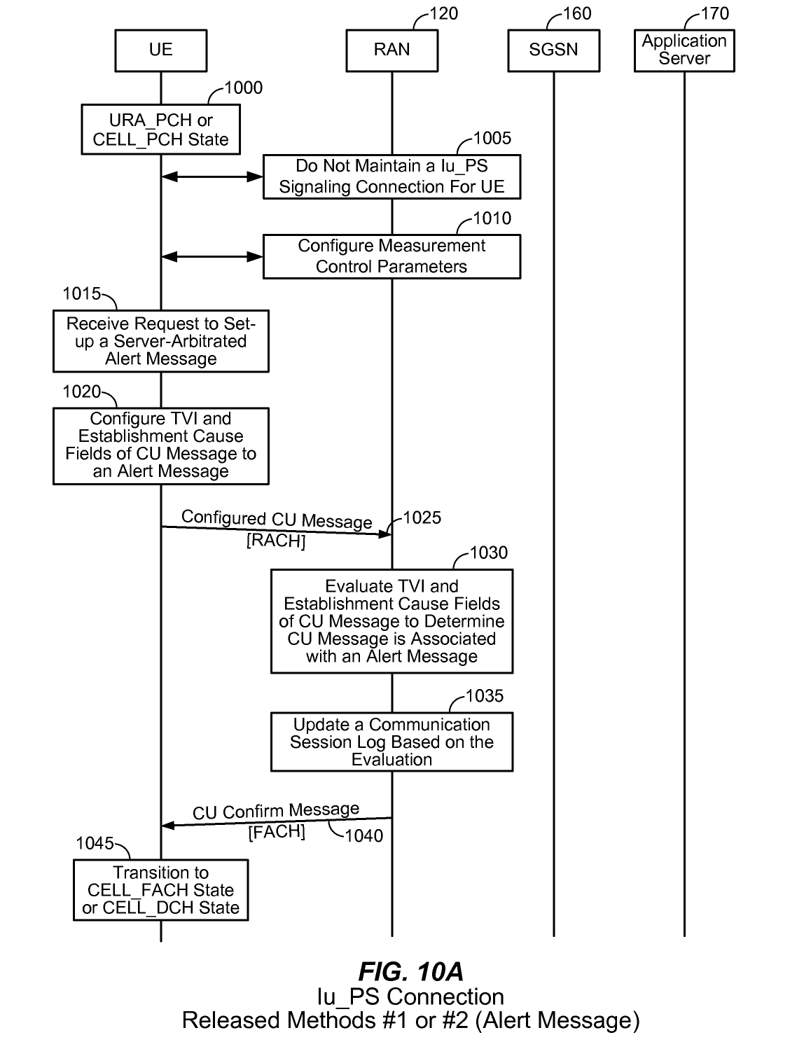

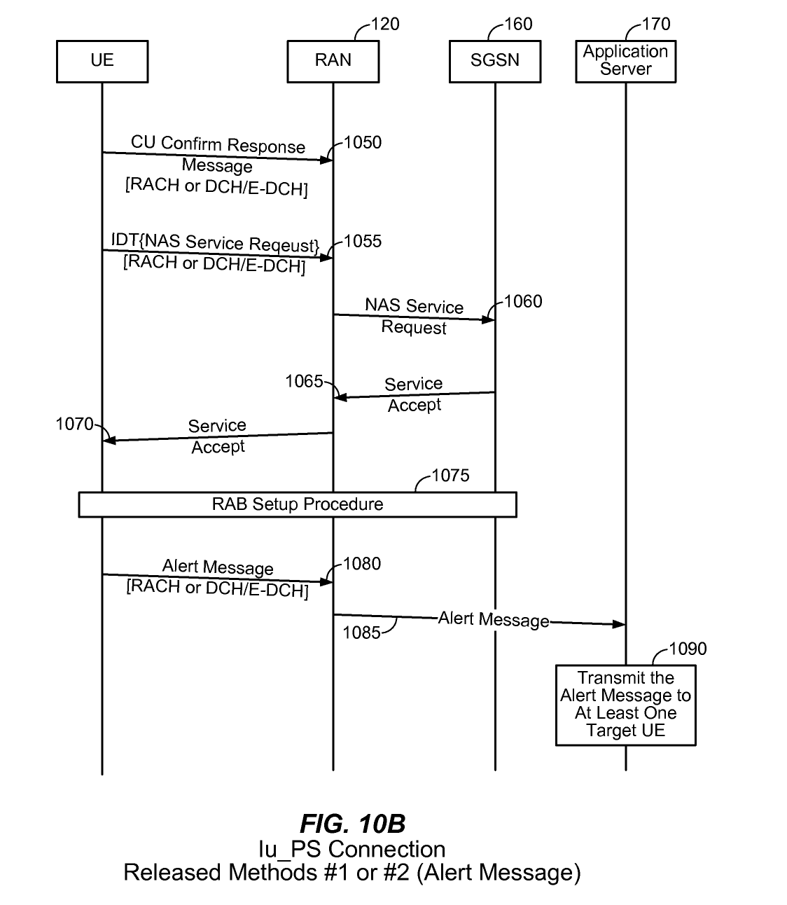

FIGS. 9A-9B illustrate an example implementation of FIGS. 8A-8B where the given type of communication session being set-up corresponds to a direct call session to be arbitrated by the application server 170 in accordance with an embodiment of the invention and FIGS. 10A-10B illustrate another example implementation of FIGS. 8A-8B where the given type of communication session being set-up corresponds to an alert message session to be arbitrated by the application server 170 in accordance with another embodiment of the invention.

Referring to FIGS. 9A-9B, 900 through 985 of FIGS. 9A-9B substantially correspond to 800 through 885 of FIGS. 8A-8B, respectively, except that FIGS. 9A-9B are illustrated more specifically to the given type of the communication session being a direct call session. For example, 915 is shown as receiving a request to set-up a server-arbitrated direct PS call, and so on. After the application server 170 receives the call request message at 985, the application server 170 sets up the direct call session between the originating UE and at least one target UE, 990. For example, while not shown explicitly in FIGS. 9A-9B, the application server 170 can identify one or more target UEs based on the call request message and then announce the direct call session to the identified target UE(s) while waiting for at least one of the target UE(s) to accept the announced communication session. Also, the decision logic executed by the RAN 120 at 930 may be specific to the direct PS call determination for scenarios where the Iu-PS signaling connection is not maintained for dormant UEs (e.g., 615B of FIG. 6B, 630C of FIG. 6C and/or 650D of FIG. 6D).

Similarly, referring to FIGS. 10A-10B, 1000 through 1085 of FIGS. 10A-10B substantially correspond to 800 through 885 of FIGS. 8A-8B, respectively, except that FIGS. 10A-10B are illustrated more specifically to the given type of the communication session being an alert message session. For example, 1010 is shown as receiving a request to transmit a server-arbitrated alert message, and so on. After the application server 170 receives the alert message at 1085, the application server 170 transmits the alert message to at least one target UE, 1090. For example, while not shown explicitly in FIGS. 10A-10B, the application server 170 can identify one or more target UEs based on the alert message and then transmit the alert message to the target UE(s). Also, the decision logic executed by the RAN 120 at 1030 may be specific to the alert message determination for scenarios where the Iu-PS signaling connection is not maintained for dormant UEs (e.g., 620B of FIG. 6B, 635C of FIG. 6C and/or 655D of FIG. 6D).

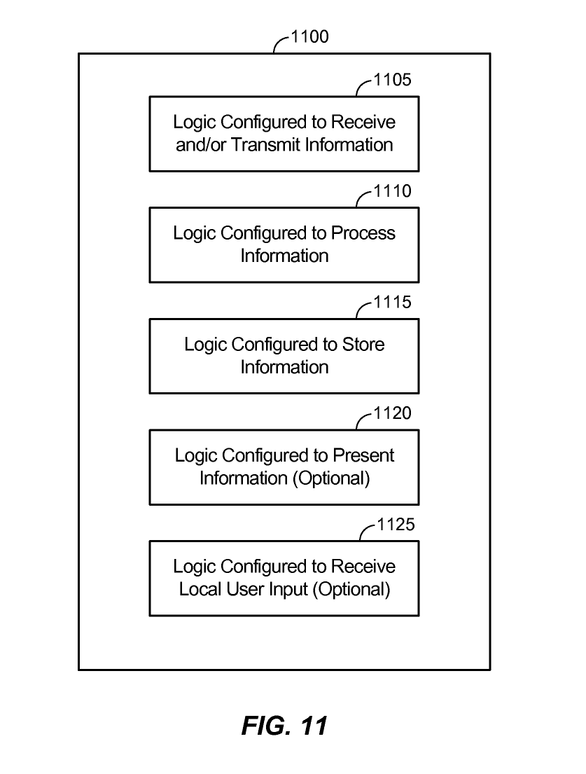

FIG. 11 illustrates a communication device 1100 that includes logic configured to perform functionality in accordance with an embodiment of the invention. The communication device 1100 can correspond to any of the above-noted communication devices, including but not limited to UEs 102, 108, 110, 112 or 200, Node Bs or base stations 120, the RNC or base station controller 122, a packet data network end-point (e.g., SGSN 160, GGSN 165, etc.), any of the servers 170 through 186, etc. Thus, communication device 1100 can correspond to any electronic device that is configured to communicate with (or facilitate communication with) one or more other entities over a network.

As will be appreciated by one of ordinary skill in the art, the logged session data discussed above with respect to FIGS. 4A through 10B can permit an operator of the RAN 120 to administer network resources in a more efficient manner. For example, by leveraging on accurate call-type statistics, the operator of the RAN 120 can derive a reliable call model to optimize Capital expenditures (CAPEX) as the number of service subscriber increases.

Referring to FIG. 11, the communication device 1100 includes logic configured to receive and/or transmit information 1105. In an example, if the communication device 1100 corresponds to a wireless communications device (e.g., UE 200, Node B 124, etc.), the logic configured to receive and/or transmit information 1105 can include a wireless communications interface (e.g., Bluetooth, WiFi, 2G, 3G, etc.) such as a wireless transceiver and associated hardware (e.g., an RF antenna, a MODEM, a modulator and/or demodulator, etc.). In another example, the logic configured to receive and/or transmit information 1105 can correspond to a wired communications interface (e.g., a serial connection, a USB or Firewire connection, an Ethernet connection through which the Internet 175 can be accessed, etc.). Thus, if the communication device 1100 corresponds to some type of network-based server (e.g., SGSN 160, GGSN 165, application server 170, etc.), the logic configured to receive and/or transmit information 1105 can correspond to an Ethernet card, in an example, that connects the network-based server to other communication entities via an Ethernet protocol. In a further example, the logic configured to receive and/or transmit information 1105 can include sensory or measurement hardware by which the communication device 1100 can monitor its local environment (e.g., an accelerometer, a temperature sensor, a light sensor, an antenna for monitoring local RF signals, etc.). The logic configured to receive and/or transmit information 1105 can also include software that, when executed, permits the associated hardware of the logic configured to receive and/or transmit information 1105 to perform its reception and/or transmission function(s). However, the logic configured to receive and/or transmit information 1105 does not correspond to software alone, and the logic configured to receive and/or transmit information 1105 relies at least in part upon hardware to achieve its functionality.

Referring to FIG. 11, the communication device 1100 further includes logic configured to process information 1110. In an example, the logic configured to process information 1110 can include at least a processor. Example implementations of the type of processing that can be performed by the logic configured to process information 1110 includes but is not limited to performing determinations, establishing connections, making selections between different information options, performing evaluations related to data, interacting with sensors coupled to the communication device 1100 to perform measurement operations, converting information from one format to another (e.g., between different protocols such as .wmv to .avi, etc.), and so on. For example, the processor included in the logic configured to process information 1110 can correspond to a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 1110 can also include software that, when executed, permits the associated hardware of the logic configured to process information 1110 to perform its processing function(s). However, the logic configured to process information 1110 does not correspond to software alone, and the logic configured to process information 1110 relies at least in part upon hardware to achieve its functionality.

Referring to FIG. 11, the communication device 1100 further includes logic configured to store information 1115. In an example, the logic configured to store information 1115 can include at least a non-transitory memory and associated hardware (e.g., a memory controller, etc.). For example, the non-transitory memory included in the logic configured to store information 1115 can correspond to RAM memory, flash memory, ROM memory, EPROM memory, EEPROM memory, registers, hard disk, a removable disk, a CD-ROM, or any other form of storage medium known in the art. The logic configured to store information 1115 can also include software that, when executed, permits the associated hardware of the logic configured to store information 1115 to perform its storage function(s). However, the logic configured to store information 1115 does not correspond to software alone, and the logic configured to store information 1115 relies at least in part upon hardware to achieve its functionality.

Referring to FIG. 11, the communication device 1100 further optionally includes logic configured to present information 1120. In an example, the logic configured to present information 1120 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 1100. For example, if the communication device 1100 corresponds to UE 200 as shown in FIG. 3, the logic configured to present information 1120 can include the display 224. In a further example, the logic configured to present information 1120 can be omitted for certain communication devices, such as network communication devices that do not have a local user (e.g., network switches or routers, remote servers, etc.). The logic configured to present information 1120 can also include software that, when executed, permits the associated hardware of the logic configured to present information 1120 to perform its presentation function(s). However, the logic configured to present information 1120 does not correspond to software alone, and the logic configured to present information 1120 relies at least in part upon hardware to achieve its functionality.

Referring to FIG. 11, the communication device 1100 further optionally includes logic configured to receive local user input 1125. In an example, the logic configured to receive local user input 1125 can include at least a user input device and associated hardware. For example, the user input device can include buttons, a touch-screen display, a keyboard, a camera, an audio input device (e.g., a microphone or a port that can carry audio information such as a microphone jack, etc.), and/or any other device by which information can be received from a user or operator of the communication device 1100. For example, if the communication device 1100 corresponds to UE 200 as shown in FIG. 3, the logic configured to receive local user input 1125 can include the display 224 (if implemented a touch-screen), keypad 226, etc. In a further example, the logic configured to receive local user input 1125 can be omitted for certain communication devices, such as network communication devices that do not have a local user (e.g., network switches or routers, remote servers, etc.). The logic configured to receive local user input 1125 can also include software that, when executed, permits the associated hardware of the logic configured to receive local user input 1125 to perform its input reception function(s). However, the logic configured to receive local user input 1125 does not correspond to software alone, and the logic configured to receive local user input 1125 relies at least in part upon hardware to achieve its functionality.

Referring to FIG. 11, while the configured logics of 1105 through 1125 are shown as separate or distinct blocks in FIG. 11, it will be appreciated that the hardware and/or software by which the respective configured logic performs its functionality can overlap in part. For example, any software used to facilitate the functionality of the configured logics of 1105 through 1125 can be stored in the non-transitory memory associated with the logic configured to store information 1115, such that the configured logics of 1105 through 1125 each performs their functionality (i.e., in this case, software execution) based in part upon the operation of software stored by the logic configured to store information 1105. Likewise, hardware that is directly associated with one of the configured logics can be borrowed or used by other configured logics from time to time. For example, the processor of the logic configured to process information 1110 can format data into an appropriate format before being transmitted by the logic configured to receive and/or transmit information 1105, such that the logic configured to receive and/or transmit information 1105 performs its functionality (i.e., in this case, transmission of data) based in part upon the operation of hardware (i.e., the processor) associated with the logic configured to process information 1110. Further, the configured logics or “logic configured to” of 1105 through 1125 are not limited to specific logic gates or elements, but generally refer to the ability to perform the functionality describe herein (either via hardware or a combination of hardware and software). Thus, the configured logics or “logic configured to” of 1105 through 1125 are not necessarily implemented as logic gates or logic elements despite sharing the word “logic”. Other interactions or cooperation between the configured logics 1105 through 1125 will become clear to one of ordinary skill in the art from a review of the embodiments described above.

While references in the above-described embodiments of the invention have generally used the terms ‘call’ and ‘session’ interchangeably, it will be appreciated that any call and/or session is intended to be interpreted as inclusive of actual calls between different parties, or alternatively to data transport sessions that technically may not be considered as ‘calls’. Also, while above-embodiments have generally described with respect to PTT sessions, other embodiments can be directed to any type of communication session, such as a push-to-transfer (PTX) session, an emergency VoIP call, etc.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., access terminal). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of operating a user equipment (UE) in a wireless communications system, comprising:
receiving a request to set-up a communication session of a given type while the UE is in a dormant state;
configuring a state transition request message (i) to request that an access network transition the UE from the dormant state to a target state and to obtain a network-assigned serving cell-specific identifier for exchanging data between the UE and the serving cell in association with the communication session of the given type and (ii) to indicate the given type of the communication session; and
transmitting the state transition request message to the access network.

2. The method of claim 1, wherein the state transition request message is configured to indicate that the given type of the communication session corresponds to (i) a circuit-switched (CS) call, (ii) a direct packet-switched (PS) call, (iii) a direct PS call with Iu-ps signaling released, (iv) a PS alert message and/or (v) a PS alert message with Iu-ps signaling released.

3. The method of claim 1, wherein the state transition request message corresponds to a cell update message.

4. The method of claim 3, wherein the given type of the communication session is indicated by the cell update message based on (i) a first field of the cell update message, (ii) a second field of the cell update message, and/or (iii) whether an Initial Direct Transfer (IDT) message is transmitted in conjunction with the cell update message.

5. The method of claim 4, wherein the first field corresponds to a Traffic Volume Indicator (TVI) field of the cell update message and the second field corresponds to an Establishment Cause field of the cell update message.

6. The method of claim 4, wherein the configuring step configures the cell update message to indicate the given type of the communication session by scheduling transmission of the IDT message in a circuit switched (CS) domain in conjunction with transmission of the cell update message.

7. The method of claim 6, wherein the cell update message is configured to indicate that the given type of the communication session corresponds to a CS call.

8. The method of claim 4,
wherein an Iu-PS signaling connection is maintained during the receiving, configuring and transmitting steps,
and wherein the configuring step configures the cell update message to indicate the given type of the communication session by (i) not scheduling transmission of the IDT message in a circuit switched (CS) domain in conjunction with transmission of the cell update message, and (ii) applying a given configuration or bit-setting to the second field of the cell update message.

9. The method of claim 8,
wherein the given configuration or bit-setting applied to the second field of the cell update message is configured to indicate that the given type of the communication session corresponds to a direct packet-switched (PS) call or a PS alert message.

10. The method of claim 4, wherein the configuring step configures the cell update message to indicate the given type of the communication session by (i) applying a given configuration or bit-setting to the first field of the cell update message, and (ii) applying another given configuration or bit-setting to the second field of the cell update message.

11. The method of claim 10, wherein the cell update message is configured to indicate that the given type of the communication session corresponds to a direct packet-switched (PS) call or a PS alert message.

12. The method of claim 4, wherein the configuring step configures the cell update message to indicate the given type of the communication session by (i) applying a given configuration or bit-setting to the first field of the cell update message, and (ii) scheduling transmission of the IDT message in a circuit switched (CS) domain in conjunction with transmission of the cell update message.

13. The method of claim 12, wherein the cell update message is configured to indicate that the given type of the communication session corresponds to a CS call.

14. The method of claim 4, wherein the configuring step configures the cell update message to indicate the given type of the communication session by (i) applying a given configuration or bit-setting to the first field of the cell update message, and (ii) not scheduling transmission of the IDT message in a circuit switched (CS) domain in conjunction with transmission of the cell update message.

15. The method of claim 14, wherein the cell update message is configured to indicate that the given type of the communication session corresponds to a packet switched (PS) call.

16. The method of claim 4, wherein the configuring step configures the cell update message to indicate the given type of the communication session by (i) not scheduling transmission of the IDT message in a circuit switched (CS) domain in conjunction with transmission of the cell update message, and (ii) applying a given configuration or bit-setting to the second field of the cell update message.

17. The method of claim 16, wherein the cell update message is configured to indicate that the given type of the communication session corresponds to a packet switched (PS) call.

18. The method of claim 4, wherein the configuring step configures the cell update message to indicate the given type of the communication session by (i) not scheduling transmission of the IDT message in a circuit switched (CS) domain in conjunction with transmission of the cell update message, (ii) applying a given configuration or bit-setting to the first of the cell update message and (iii) applying another given configuration or bit-setting to the second field of the cell update message.

19. The method of claim 18, wherein the cell update message is configured to indicate that the given type of the communication session corresponds to a direct packet-switched (PS) call or a PS alert message.

20. The method of claim 4, wherein the configuring step configures the cell update message to indicate the given type of the communication session by not scheduling transmission of the IDT message in a circuit switched (CS) domain or a packet switched (PS) domain in conjunction with transmission of the cell update message.

21. The method of claim 20, wherein the second field of the cell update message is configured to indicate that the given type of the communication session corresponds to a direct packet-switched (PS) call or a PS alert message.

22. The method of claim 4, wherein the configuring step configures the cell update message to indicate the given type of the communication session by (i) scheduling transmission of the IDT message in a packet switched (PS) domain in conjunction with transmission of the cell update message, (ii) not scheduling transmission of the IDT message in a circuit switched (CS) domain in conjunction with transmission of the cell update message and (iii) applying a given configuration or bit-setting to the first field and/or the second field of the cell update message.

23. The method of claim 22, wherein the cell update message is configured to indicate that the given type of the communication session corresponds to a direct packet-switched (PS) call with Iu-ps signaling released or a PS alert message with Iu-ps signaling released.

24. The method of claim 1, further comprising:
maintaining an Iu-packet switched (PS) signaling connection between the UE and an application server configured to arbitrate the communication session,
wherein the given type of the communication session is indicated based in part upon the always-on Iu-PS signaling connection being available during the receiving, configuring or transmitting steps.

25. The method of claim 1, further comprising:
establishing, prior to the receiving step, measurement control and/or traffic volume measurement (TVM) parameters indicative of a manner by which the state transition request message can be configured to indicate the given type of the communication session,
wherein an Iu-packet switched (PS) signaling connection between the UE and an application server configured to arbitrate the communication session is not maintained such that the receiving step receives the request while the Iu-PS signaling connection is not available;
wherein the given type of the communication session is indicated based in part upon the established measurement control and/or TVM parameters.

26. The method of claim 1, wherein the network-assigned serving cell-specific identifier corresponds to a Cell Radio Network Temporary Identifier (C-RNTI).

27. The method of claim 1, wherein the dormant state corresponds to CELL_PCH state or URA_PCH state.

28. The method of claim 1, wherein the target state corresponds to a shared channel state.

29. The method of claim 28, wherein the shared channel state corresponds to CELL_FACH state.

30. The method of claim 1, wherein the target state corresponds to a dedicated channel state.

31. The method of claim 30, wherein the dedicated channel state corresponds to CELL_DCH state.

32. A method of operating an access network in communication with a user equipment (UE) in a wireless communications system, comprising:
receiving a state transition request message that requests the UE to be transitioned from a dormant state into a target state and to obtain a network-assigned serving cell-specific identifier for exchanging data between the UE and the serving cell in association with a communication session of a given type; and
determining the given type of the communication session based on the state transition request message.

33. The method of claim 32, wherein the determining step determines that the given type of the communication session corresponds to (i) a circuit-switched (CS) call, (ii) a direct packet-switched (PS) call, (iii) a direct PS call with Iu-ps signaling released, (iv) a PS alert message and/or (v) a PS alert message with Iu-ps signaling released.

34. The method of claim 32, further comprising:
updating a communication session log based on the determination.

35. The method of claim 34, wherein the communication session log maintains sector-specific session-type statistics.

36. The method of claim 33, wherein the state transition request message corresponds to a cell update message.

37. The method of claim 36, wherein the determining step determines the given type of the communication session based on (i) a first field of the cell update message, (ii) a second field of the cell update message, and/or (iii) whether an Initial Direct Transfer (IDT) message is received in conjunction with the cell update message.

38. The method of claim 37, wherein the first field corresponds to a Traffic Volume Indicator (TVI) field of the cell update message and the second field corresponds to an Establishment Cause field of the cell update message.

39. The method of claim 37, wherein the determining step determines the given type of the communication session based on whether the IDT message is received in a circuit switched (CS) domain in conjunction with receiving of the cell update message.

40. The method of claim 39, wherein the determining step determines that the given type of the communication session corresponds to a CS call.

41. The method of claim 37, wherein the determining step determines the given type of the communication session based on (i) not receiving the IDT message in a circuit switched (CS) domain in conjunction with receiving the cell update message, and (ii) detecting a given configuration or bit-setting within the second field of the cell update message.

42. The method of claim 41,
wherein an Iu-PS signaling connection is maintained during the receiving and determining steps,
and wherein the determining step determines that the given type of the communication session corresponds to a direct packet-switched (PS) call or a PS alert message.

43. The method of claim 37, wherein the determining step determines the given type of the communication session based on (i) detecting a given configuration or bit-setting within the first field of the cell update message, and (ii) detecting another given configuration or bit-setting within the second field of the cell update message.

44. The method of claim 43, wherein the determining step determines that the given type of the communication session corresponds to a direct packet-switched (PS) call or a PS alert message.

45. The method of claim 37, wherein the determining step determines the given type of the communication session based on (i) detecting a given configuration or bit-setting within the first field of the cell update message, and (ii) receiving the IDT message in a circuit switched (CS) domain in conjunction with receiving the cell update message.

46. The method of claim 45, wherein the determining step determines that the given type of the communication session corresponds to a CS call.

47. The method of claim 37, wherein the determining step determines the given type of the communication session based on (i) detecting a given configuration or bit-setting within the first field of the cell update message, and (ii) not receiving the IDT message in a circuit switched (CS) domain in conjunction with receiving the cell update message.

48. The method of claim 47, wherein the determining step determines that the given type of the communication session corresponds to a packet switched (PS) call.

49. The method of claim 37, wherein the determining step determines the given type of the communication session based on (i) not receiving the IDT message in a circuit switched (CS) domain in conjunction with receiving the cell update message, and (ii) detecting a given configuration or bit-setting within the second field of the cell update message.

50. The method of claim 49, wherein the determining step determines that the given type of the communication session corresponds to a packet switched (PS) call.

51. The method of claim 37, wherein the determining step determines the given type of the communication session based on (i) not receiving the IDT message in a circuit switched (CS) domain in conjunction with receiving the cell update message, (ii) detecting a given configuration or bit-setting within the first field of the cell update message and (iii) detecting another given configuration or bit-setting within the second field of the cell update message.

52. The method of claim 51, wherein the determining step determiners that the given type of the communication session corresponds to a direct packet-switched (PS) call or a PS alert message.

53. The method of claim 37, wherein the determining step determines the given type of the communication session based on not receiving the IDT message in a circuit switched (CS) or a packet switched (PS) domain in conjunction with receiving the cell update message.

54. The method of claim 53, wherein the determining step determines that the given type of the communication session corresponds to a direct packet-switched (PS) call or a PS alert message.

55. The method of claim 37, wherein the determining step determines the given type of the communication session based on (i) receiving the IDT message in a packet switched (PS) domain in conjunction with receiving the cell update message, (ii) not receiving the IDT message in a circuit switched (CS) domain in conjunction with receiving the cell update message and (iii) detecting a given configuration or bit-setting within the first field and/or the second field of the cell update message.

56. The method of claim 55, wherein the determining step determines that the given type of the communication session corresponds to a direct packet-switched (PS) call with Iu-ps signaling released or a PS alert message with Iu-ps signaling released.

57. The method of claim 32, further comprising:
maintaining an Iu-packet switched (PS) signaling connection between the UE and an application server configured to arbitrate the communication session,
wherein the determining step determines the given type of the communication session based in part upon the always-on Iu-PS signaling connection being maintained.

58. The method of claim 32, further comprising:
establishing, prior to the receiving step, measurement control and/or traffic volume measurement (TVM) parameters indicative of a manner by which the state transition request message can be configured to indicate the given type of the communication session,
wherein an Iu-packet switched (PS) signaling connection between the UE and an application server configured to arbitrate the communication session is not maintained such that the receiving step receives the request while the Iu-PS signaling connection is not available, and
wherein the determining step determines the given type of the communication session based in part upon the established measurement control and/or TVM parameters.

59. The method of claim 32, wherein the network-assigned serving cell-specific identifier corresponds to a Cell Radio Network Temporary Identifier (C-RNTI).

60. The method of claim 32, wherein the dormant state corresponds to CELL_PCH state or URA_PCH state.

61. The method of claim 32, wherein the target state corresponds to a shared channel state.

62. The method of claim 61, wherein the shared channel state corresponds to CELL_FACH state.

63. The method of claim 32, wherein the target state corresponds to a dedicated channel state.

64. The method of claim 63, wherein the dedicated channel state corresponds to CELL_DCH state.

65. A user equipment (UE) in a wireless communications system, comprising:
means for receiving a request to set-up a communication session of a given type while the UE is in a dormant state;
means for configuring a state transition request message (i) to request that an access network transition the UE from the dormant state to a target state and to obtain a network-assigned serving cell-specific identifier for exchanging data between the UE and the serving cell in association with the communication session of the given type and (ii) to indicate the given type of the communication session; and
means for transmitting the state transition request message to the access network.

66. An access network in communication with a user equipment (UE) in a wireless communications system, comprising:
means for receiving a state transition request message that requests the UE to be transitioned from a dormant state into a target state and to obtain a network-assigned serving cell-specific identifier for exchanging data between the UE and the serving cell in association with a communication session of a given type; and
means for determining the given type of the communication session based on the state transition request message.

67. A user equipment (UE) in a wireless communications system, comprising:
logic configured to receive a request to set-up a communication session of a given type while the UE is in a dormant state;
logic configured to configure a state transition request message (i) to request that an access network transition the UE from the dormant state to a target state and to obtain a network-assigned serving cell-specific identifier for exchanging data between the UE and the serving cell in association with the communication session of the given type and (ii) to indicate the given type of the communication session; and
logic configured to transmit the state transition request message to the access network.

68. An access network in communication with a user equipment (UE) in a wireless communications system, comprising:
logic configured to receive a state transition request message that requests the UE to be transitioned from a dormant state into a target state and to obtain a network-assigned serving cell-specific identifier for exchanging data between the UE and the serving cell in association with a communication session of a given type; and
logic configured to determine the given type of the communication session based on the state transition request message.

69. A non-transitory computer-readable medium containing instructions stored thereon, which, when executed by a user equipment (UE) in a wireless communications system, cause the UE to perform operations, the instructions comprising:
program code to receive a request to set-up a communication session of a given type while the UE is in a dormant state;
program code to configure a state transition request message (i) to request that an access network transition the UE from the dormant state to a target state and to obtain a network-assigned serving cell-specific identifier for exchanging data between the UE and the serving cell in association with the communication session of the given type and (ii) to indicate the given type of the communication session; and
program code to transmit the state transition request message to the access network.

70. A non-transitory computer-readable medium containing instructions stored thereon, which, when executed by an access network in communication with a user equipment (UE) in a wireless communications system, cause the access network to perform operations, the instructions comprising:
program code to receive a state transition request message that requests the UE to be transitioned from a dormant state into a target state and to obtain a network-assigned serving cell-specific identifier for exchanging data between the UE and the serving cell in association with a communication session of a given type; and
program code to determine the given type of the communication session based on the state transition request message.
